(19) United States
(12) Patent Application Publication
(10) Pub. No.: US 2020/0108399 A1
(43) Pub. Date: Apr. 9, 2020

(54) Method for Recycling Electronic Materials, Products and Components Thereof, and End Products Produced Thereby

(71) Applicant: Owl Electronic Recycling Technology Inc., Dover, DE (US)

(72) Inventor: Zhen Dong Wen, Marlboro, NJ (US)

(21) Appl. No.: 16/184,833

(22) Filed: Nov. 8, 2018

Related U.S. Application Data
(60) Provisional application No. 62/743,463, filed on Oct. 9, 2018.

(51) Int. Cl. B03B 9/06; B29B 17/02; C22B 7/00; B02C 23/14; B03B 5/30; B03B 7/00

(52) U.S. Cl. CPC B03B 9/06; B29B 17/02; C22B 7/006; B03C 1/02; B03B 5/30; B03B 7/00; B02C 23/14

(57) ABSTRACT

Method for recycling electronic waste are included that enable electronic waste separation and recycling to a high level of separation efficiency and end product purity which are improvements over prior methods. In preferred methods, separated electronic waste which has been subjected to magnetic separation to remove ferrous materials and shredded to an average width of less than about 40 mm is provided and then introduced to a first water tank treated so as to have a specific gravity of about 1.20 to about 1.30 and allowing a first portion of the electronic waste to float in the first water tank and a second portion of the electronic waste to sink in the first water tank; and the second portion of the electronic waste is introduced to a water vibrating table, wherein the remaining second portion of the electronic waste leaving the water vibrating table yields at least about 98% sorted recovered materials comprising pure and clean copper, aluminum, wire, circuit boards, stainless steel and mixed plastics. Other preferred embodiments employ use of a horizontal friction dehydrator in secondary separation, use of color sorting of various plastics, employing fresh-water fed vertical dehydrators at end steps of separation and use of a high purity electrostatic separation process for final products.

### CROSS-REFERENCE TO RELATED APPLICATIONS

This claims the benefit under 35 U.S.C. § 119(e) of U.S. Provisional Patent Application No. 62/743,463, filed Oct. 9, 2018, entitled, “Method for Recycling Electronic Materials, Products and Components Thereof,” the entire disclosure of which is incorporated herein by reference.

### BACKGROUND OF THE INVENTION

### Field of the Invention

The invention relates to the field of processing electronic waste through a recycling process to yield high purity metallic and plastic products as well as other separated end products.

### Description of Related Art

Electronic products have become ubiquitous in our society. The more of such products that are made, the more the electronic waste that is generated. The increasing demand and fast replacement of devices such as computer desktops, laptops, mobile phones, cameras and the like also adds to the amount of electronic waste being generated, and to the ever increasing types of materials that need to be processed for recycling. Handling the waste and re-use of materials from electronic products and their components is difficult, as each device includes many different materials and types of components (metals, composites, rubber, plastic, wire, circuit boards and the like). Initial processes developed included incineration or chemical-based processes which caused contamination and toxic additions to landfills as well as contamination of the ground and water in areas near such initial processing plants. Such contaminating processes are well-documented to have caused contamination in China, which is known to be one of the largest recipients of such waste from e-dumping and is also a very large producer of such items (2.3 million tons as of 2010), second only to the U.S.

According to the National Conference of State Legislatures (NCSL), Americans own about 24 such electronic products per household on average with sales of such products now greater than 206 billion dollars. The NCSL also reports that the U.S. Environmental Protection Agency (EPA) estimates almost 2.4 million tons of electronics were disposed of in 2009, which is a 120% increase over 1999, with only 25% being recycled. See, http://www.ncsl.org/research/environment-and-natural-resource/ (2018). Some put the amount recycled even lower. The NCSL also relays that various states in the U.S. have different approaches to recycling. About half of the states and the District of Columbia have statewide e-waste recycling programs. Some manufacturers and retailers also offer return programs for their products. Other states levy a fee on such goods that funds state recycling programs.

Unlike standard recycling, where a consumer can divide certain types of paper, plastic and metal goods, the ability to do consumer separation with electronic components is much more difficult causing consumers to seek out specialty disposal areas or to inappropriately drop such components in the standard refuse. Some people stockpile such materials for long periods of time so that by the time the combination of materials are sent for disposal they may encompass many different electronic components with older and newer components in combination.

Electronic waste, which is also known as “e-waste” can include harmful materials such as mercury, cadmium, beryllium, brominated flame retardants, lead, lithium and other hazardous material if dumped into landfill and/or if improperly disposed of through chemical means or incineration. It can be the result of televisions, monitors, computers, laptops, computer mice, keyboards, servers, printers and scanners, tablets, MP3 players, video recorders, DVD and DVR players, facsimile machines, video game players and cable boxes. E-waste is also “traded” as hazardous waste in the waste and recycling industries. The U.S. attempts to ship its e-waste to other countries as well as the U.S. If recycling is done incorrectly, it can result in harm to human health and environmental contamination. While some recycling processes are now “E-Steward” certified, not all meet certification standards. The average consumer would only know this if contacting his or her local waste management department and inquiring into how best to recycle e-waste and whether the township or city has a certified program. Some retailers now have their own certified programs working with various recycling programs. There are also grassroots programs, such as the Certified Electronics Recycler program for electronics recyclers that provides integrated management systems standards for operational health and safety.

If properly recycled, e-waste can yield valuable materials like plastics, steel, and other metals like copper, gold, aluminum and silver. Re-use of such materials reduces an overall energy footprint and helps reduce environmental contamination. Printed Circuit Boards (PCBs) can yield precious metals (gold, silver, platinum) as well as base metals (copper, aluminum and iron). Methods are known for acid pit leaching, melting and burning for separation. These are effective, but can be environmental issues. Other mechanical shredding and separation methods are known, but tend to have low yield and recycling efficiencies. In some processing techniques, the first step is dismantling the equipment into parts such as metallic frames, power supplies, PCBs, plastic parts and the like either by hand or using automated shredders. Screening and granulating machines are also used for further separation of metal and plastic fractions that can be sold to smelters or other recycling processes. Also employed are magnets, eddy currents and other screens for separation.

The applicant herein developed a proprietary process used in China for e-waste recycling based on a series of salt water sink/float tanks of differing specific gravity which work with other components to separate e-waste of varying types. The process was successful, and, while efficient, yielded only 80% pure clean high level recoverable materials such as copper, aluminum, wire, circuit boards, stainless steel and mixed plastics.

A similar process is also described in several Chinese patents along with related equipment based on applicant's prior process including Chinese Utility Patents Nos. 20724050598 U, 207240597 U, 207240595 U and Chinese Published Applications Nos. 107639765 A and 107471485 A.

While such processes are similar to that of applicant's original proprietary process, there remains a need in the art to achieve a sufficiently high yield. For recycling to become more lucrative financially so as to supplant local or other ineffective processes (or contaminating processes), there is a need in the art to improve overall recycling efficiency and yield to sufficiently cover energy and operational costs associated with e-waste recycling.

### BRIEF SUMMARY OF THE INVENTION

The present invention includes various methods and embodiments for recycling electronic waste and products made according to such methods.

In one embodiment, herein the invention includes a method for recycling electronic waste, comprising: (a) providing separated electronic waste which has been subjected to magnetic separation to remove ferrous materials and shredded to an average width of less than about 40 mm; (b) introducing the electronic waste from step (a) to a first water tank treated so as to have a specific gravity of about 1.20 to about 1.30 and allowing a first portion of the electronic waste to float in the first water tank and a second portion of the electronic waste to sink in the first water tank; and (c) introducing the second portion of the electronic waste from step (b) to a water vibrating table, wherein the remaining second portion of the electronic waste from step (b) leaving the water vibrating table yields at least about 98% sorted recovered materials comprising pure and clean copper, aluminum, wire, circuit boards, stainless steel and mixed plastics. The invention further includes a product made according to such method. In a further embodiment, products made according to such method leaving the water vibrating table yield at least about 99% sorted recovered materials comprising pure and clean copper, aluminum, wire, circuit boards, stainless steel and mixed plastics.

In the method noted above, the method may further comprise introducing the first portion of the electronic waste from step (b) to a vibrating screen dryer. The method may also further comprise introducing the dried first portion of the electronic waste from step (b) to a second water tank treated to have a specific gravity of about 1.10 to about 1.19, wherein a third portion of the electronic waste is allowed to float in the second water tank and a fourth portion of the electronic waste is allowed to sink in the second water tank; and (d) introducing the third portion of the electronic waste from step (c) to a horizontal friction dehydrator situated at an angle of about 5 degrees to about 40 degrees from a horizontal mounting plane of the horizontal friction dehydrator to reduce water content in the third portion of the electronic waste from the second water tank and to assist in removal of at least dirt and labels from the third portion of the electronic waste from step (c) to facilitate sorting.

The method may also further comprise a step (e) of introducing the fourth portion of the electronic waste from step (c) to a first vertical dehydrator, and (f) introducing the fourth portion of the electronic waste leaving the first vertical dehydrator into a color sorter to separate light colors from dark colors; and (g) introducing the dark colored electronic waste into an X-ray sorter and introducing the light colored electronic waste into an infrared sorter to provide sorted plastics at about a 95% to about a 98% sorting efficiency of at least one of pure fiber reinforced acrylonitrile-butadiene-styrene, fiber reinforced polystyrene, polycarbonate, a polycarbonate-acrylonitrile-butadiene-styrene blend, acrylonitrile-butadiene-styrene, polyamide and polymethylmethacrylate. The dark colored electronic waste may be introduced into a first silo and preferably comprises a mixture of fiber reinforced acrylonitrile-butadiene-styrene and fiber reinforced polystyrene.

In a further embodiment of the method described herein, the electronic waste in the first silo may be introduced to an electrostatic separation process.

The method may also further comprise introducing the third portion of electronic waste leaving the horizontal friction dehydrator to a shredder mechanism to reduce average width of the electronic waste to less than about 14 mm. The third portion of electronic waste leaving the shredder mechanism may be introduced to a third water tank and a fifth portion of electronic waste from the shredder mechanism may then be allowed to float in the third water tank and a sixth portion of the electronic waste from the shredder mechanism allowed to sink in the third water tank. The fifth portion of the electronic waste and the sixth portion of the electronic waste may be each introduced to a second and third vertical dehydrator, respectively, and the dried fifth portion of the electronic waste may be introduced to a fourth water tank.

In the method, the fifth portion of the electronic waste in the fourth water tank may be allowed to float or sink, so that a seventh portion of the electronic waste in the fourth water tank floats and is fed to a fourth vertical dehydrator and the dried seventh portion of the electronic waste leaving the second fourth dehydrator may be separated and introduced to a second silo, and the eighth portion of the waste sink in the fourth water tank and may be packed. The seventh portion of the electronic waste in the second silo preferably comprises polypropylene and polyethylene. Further, in an embodiment, the seventh portion of electronic waste in the second silo may be introduced to an electrostatic separation process.

Also in the method, the sixth portion of the electronic waste leaving the third vertical dehydrator may be fed to a fifth water tank treated to have a specific gravity of about 1.05 to about 1.09 such that a ninth portion of the electronic waste in the fifth water tank floats and a tenth portion of the electronic waste sinks in the fifth water tank. The ninth and the tenth portions of the electronic waste may each be fed to respective fifth and six vertical dehydrators, wherein the ninth portion of electronic waste leaving the fifth vertical dehydrator may be fed to a sixth water tank and the tenth portion of electronic waste leaving the sixth vertical dehydrator may be fed to a seventh water tank that has been treated to have a specific gravity of about 1.10 to about 1.19. In such an embodiment, the tenth portion of electronic waste is able to sink or float in the seventh water tank such that an eleventh portion of the electronic waste in the seventh water tank floats and a twelfth portion of the electronic waste in the seventh water tank sinks, wherein the eleventh and the twelfth portions of the electronic waste in the seventh water tank are each directed to respective first and second fresh water-fed vertical dehydrators.

In such an embodiment, the twelfth portion of electronic waste leaving the second fresh-water fed vertical dehydrator may be packed and the eleventh portion of electronic waste leaving the first fresh-water fed vertical dehydrator may be separated in a separation mechanism and introduced to a third silo. The eleventh portion of the electronic waste from the third silo preferably comprises compounded acrylonitrile-butadiene-styrene, polystyrene, filler polypropylene, polyphenylene oxide and rubber. The eleventh portion of the electronic waste in the third silo may be introduced to an electrostatic separation process.

Also, in the method in one embodiment, the ninth portion of the electronic waste in the sixth water tank may be allowed to sink or float so that a thirteenth portion of the electronic waste floats and may be packed and a fourteenth portion of the electronic waste sinks and may be introduced to a seventh vertical dehydrator, separated and introduced to a fourth silo. The fourteenth portion of the electronic waste in the fourth silo preferably comprises a mixture of acrylonitrile-butadiene-styrene, polystyrene, filled polypropylene and rubber. The fourteenth portion of the electronic waste in the fourth silo may be fed to an electrostatic separation process.

The above method may be modified in various methods also within the scope of this invention. In one such embodiment, the invention includes a method for recycling electronic waste, comprising: (a) providing separated electronic waste which has been subjected to magnetic separation to remove ferrous materials and shredded to an average width of less than about 40 mm; (b) introducing the electronic waste from step (a) to a first water tank treated so as to have a specific gravity of about 1.20 to about 1.30 and allowing a first portion of the electronic waste to float in the first water tank and a second portion of the electronic waste to sink in the first water tank; and (c) introducing the first portion of the electronic waste from step (b) to a vibrating screen dryer, wherein the first portion of the electronic waste from step (b) comprises one or more of fiber reinforced polystyrene, unfilled polystyrene, fiber reinforced acrylonitrile-butadiene-styrene, unfilled acrylonitrile-butadiene-styrene, filled polyolefin, unfilled polyolefin, rubber, polycarbonate, polyamide, polymethylmethacrylate and polyphenylene oxide and wherein said vibrating screen dryer minimizes impact damage to the first portion of the electronic waste from step (b). The invention further includes products made by this method.

In another such embodiment, the method includes a method for recycling electronic waste, comprising: (a) providing separated electronic waste which has been subjected to magnetic separation to remove ferrous materials and shredded to an average width of less than about 40 mm; (b) introducing the electronic waste from step (a) to a first water tank treated so as to have a specific gravity of about 1.20 to about 1.30 and allowing a first portion of the electronic waste to float in the first water tank and a second portion of the electronic waste to sink in the first water tank; (c) drying the first portion of the electronic waste from step (b) and introducing the dried first portion of the electronic waste from step (b) to a second water tank treated to have a specific gravity of about 1.10 to about 1.19 and allowing a third portion of the electronic waste to float in the second water tank and a fourth portion of the electronic waste to sink in the second water tank; and (d) introducing the third portion of the electronic waste from step (c) to a horizontal friction dehydrator situated at an angle of about 5 degrees to about 40 degrees from a horizontal mounting plane of the horizontal friction dehydrator to reduce water content in the third portion of the electronic waste from the second water tank and to assist in removal of at least dirt and labels from the third portion of the electronic waste from step (c) to facilitate sorting. Products made according to this method are also within the invention.

Also within the invention is a method for recycling electronic waste, comprising: (a) providing separated electronic waste which has been subjected to magnetic separation to remove ferrous materials and shredded to an average width of less than about 40 mm; (b) introducing the electronic waste from step (a) to a first water tank treated so as to have a specific gravity of about 1.20 to about 1.30 and allowing a first portion of the electronic waste to float in the first water tank and a second portion of the electronic waste to sink in the first water tank; (c) drying the first portion of the electronic waste from step (b) and introducing the dried first portion of the electronic waste from step (b) to a second water tank treated to have a specific gravity of about 1.10 to about 1.19 and allowing a third portion of the electronic waste to float in the second water tank and a fourth portion of the electronic waste to sink in the second water tank; (d) introducing the fourth portion of the electronic waste from the second water tank to a vertical dehydrator; (e) introducing the fourth portion of the electronic waste leaving the vertical dehydrator into a color sorter to separate light colors from dark colors; and (f) introducing the dark colored electronic waste into an X-ray sorter and introducing the light colored electronic waste into an infrared sorter to provide sorted plastics at about a 95% to about a 98% sorting efficiency of at least one of pure fiber reinforced acrylonitrile-butadiene-styrene, fiber reinforced polystyrene, polycarbonate, a polycarbonate-acrylonitrile-butadiene-styrene blend, acrylonitrile-butadiene-styrene, polyamide and polymethylmethacrylate. Further included in the invention are products made by this process.

In another embodiment herein, the invention includes a method for recycling electronic waste, comprising: (a) provided electronic waste prepared for recycling and subjecting such electronic waste to physical separation including by introducing the electronic waste to a plurality of water tanks, some of which are treated to have a specific gravity of more than 1.0 and less than about 1.3 and allowing a first portion of the electronic waste in the plurality of water tanks to float and a second portion of the electronic waste to sink; (b) feeding separate electronic waste from one or more of the plurality of water tanks to a vertical dehydrator and a sorting apparatus; (c) loading dehydrated and sorted electronic waste from each dehydrator in step (b) into a silo; and (d) subjecting the electronic waste in each of the silos to electrostatic separation comprising applying blowers, feeding the electronic waste divided by the blowers further to a tandem rubber removal machine, using a tandem heated dryer to reduce moisture content, and separating the dry material using friction electrostatic separation. In such an embodiment, the purity of the material after the electrostatic separation is at least about 98%. Also, in such an embodiment, a portion of the material from the electrostatic separation is set aside for use in a pelletizing machine. Products made by this process are also within the scope of the invention.

Also within the invention is included a method for recycling electronic waste, comprising (a) providing electronic waste that has been reduced in average size for separation and sorting; (b) introducing the electronic waste from step (a) to a plurality of water tanks, wherein some of the plurality of water tanks are treated to have a specific gravity of greater than 1.0 to about 1.30 and some of the plurality of water tanks have a specific gravity of about 1.0; and (c) in each of the plurality of water tanks allowing a first portion of the electronic waste from step (b) to float in each of the plurality of water tanks and a second portion of the electronic waste to sink in each of the at least one water tanks, wherein one water tank of the plurality of water tanks comprises a rolling pusher mechanism to move electronic waste through the water tank, and wherein the water tank having the rolling pusher mechanism comprises a frequency converter control situated on the water tank for allowing for modification of the speed of operation of the rolling pusher mechanism.

The invention also includes a method for recycling electronic waste, comprising (a) providing electronic waste that has been reduced in average size for separation and sorting; (b) introducing the electronic waste from step (a) successively to a plurality of water tanks, wherein some of the plurality of water tanks are treated to have a specific gravity of greater than 1.0 to about 1.30 and some of the plurality of water tanks have a specific gravity of about 1.0 allowing for a first portion of the electronic waste in each of the plurality of water tanks to float and a second portion of the electronic waste in each of the plurality of water tanks to sink; and (c) introducing each of the first portion and the second portion of the electronic waste from the last of the plurality of water tanks that are treated into an independent fresh water-fed vertical dehydrator. Products made according to this method are also included within the scope of the invention.

### BRIEF DESCRIPTION OF THE SEVERAL VIEWS OF THE DRAWINGS

The foregoing summary, as well as the following detailed description of preferred embodiments of the invention, will be better understood when read in conjunction with the appended drawings. For the purpose of illustrating the invention, there is shown in the drawings embodiments which are presently preferred. It should be understood, however, that the invention is not limited to the precise arrangements and instrumentalities shown. In the drawings:

FIG. 1 is a representative flow chart of an embodiment of a method for recycling electronic waste as described herein;

FIG. 2 is a representative flow chart of an embodiment of a method for electrostatic separation of recycled electronic waste resulting from the process of FIG. 1;

FIG. 3 is representative flow chart of alternative steps of processing dried and separated electronic waste from the process of FIG. 1 prior to packing;

FIG. 4 is a representative flow chart showing water flow steps for feeding various water storage tanks used to feed water tanks used in the methods herein;

FIG. 5 is a top perspective view of a feed conveyor of initial electronic waste to the method of FIG. 1;

FIG. 6 is perspective view of a vertical shredder for initial reduction in size of electronic waste feed to the method of FIG. 1;

FIG. 7 is a perspective view of a magnetic separation unit for use in removing ferrous material from the electronic waste feed after the vertical shredder of FIG. 6;

FIG. 8 is a single shaft shredder and separator for further reduction in size of the materials in leaving the magnetic separation unit of FIG. 7;

FIG. 9 is a perspective view of a de-dust unit for removing environmental dust from the shredding process;

FIG. 10 is a conveyor belt for use in moving material from the initial shredding process to the first water tank of the method of FIG. 1;

FIG. 11 is a perspective view of an example of a first water sink/float tank for use in the method of FIG. 1;

FIG. 11A is a top view of a mechanism for removing floating material from a water tank for sink/float separation as in FIG. 11;

FIG. 11B is a perspective view of a conveyance mechanism for moving water and material from the bottom of a water tank for sink/float separation as in FIG. 11;

FIG. 12 is a perspective view of an example of a water vibrating table for use in separating materials that sink in the first water tank of FIG. 11;

FIG. 13 is a perspective view of an example of a vibrating screen dryer for use in processing materials that sink in the first water tank of FIG. 11;

FIG. 14 is a perspective view of an example of a filter press for use in processing water removed from the vibrating screen and water vibrating table of FIGS. 12 and 13 as well as from other vertical dehydrators used in the system to recover residues that may be packed;

FIG. 15 is a side perspective view of an example of a inclined horizontal friction dehydrator for use in processing material separated by floating in a second water tank in the method of FIG. 1;

FIG. 16 is a side elevational view of an example of a vertical dehydrator for use in various locations in the method of FIG. 1;

FIG. 17 is a front perspective view of an example of a color sorter for use in sorting plastics materials after a vertical dehydrator that processes materials that sink in the second water tank in the method of FIG. 1;

FIG. 18 is a front perspective view of an example of an X-ray sorter for dark plastics from the color sorter of FIG. 17;

FIG. 19 is a front perspective view of an example of an infrared sorter for light plastics from the color sorter of FIG. 17;

FIG. 20 is front perspective view of an example of a shredder/crusher for use in further reducing size of water materials leaving a horizontal friction dehydrator following the second water tank of the method of FIG. 1;

FIG. 21A is an enlarged front perspective view of an example of a zig-zag separator for use in final processing of materials prior to silo storage in various steps of the process;

FIG. 21B is a front perspective view of the zig-zag separator of FIG. 21A;

FIG. 21C is a rear perspective view of the zig-zag separator of FIG. 21A;

FIG. 21D is a side elevational view of the zig-zag separator of FIG. 21A;

FIG. 22 is a front elevational view of an example of a silo for use in the method of FIG. 1;

FIG. 23 is a front perspective view of an example of a blower for use in a first step in an electrostatic downstream separation process for use with the method of FIG. 1;

FIG. 24 is front perspective view of an example of a tandem rubber removal machine for use in the electrostatic downstream separation process for use with the method of FIG. 1;

FIG. 25 is a front perspective view of an example of a tandem heated dryer for use in the electrostatic downstream separation process for use with the method of FIG. 1;

FIG. 26 is a front perspective view of an electrostatic separator for use in the electrostatic downstream separation process for use with the method of FIG. 1;

FIG. 27 is front perspective view of a pelletizer for use after an electrostatic downstream separation process for use with the method of FIG. 1;

FIG. 28 is a front perspective view of an example of a water storage tank for use in supplying water tanks for sink/float separation in the method of FIG. 1;

FIG. 29 is a front perspective view of an example of a frequency converter control for use with the water tanks herein; and

FIG. 30 is a front view of an example of a control panel for mounting various standard controls including the frequency converter control of FIG. 29.

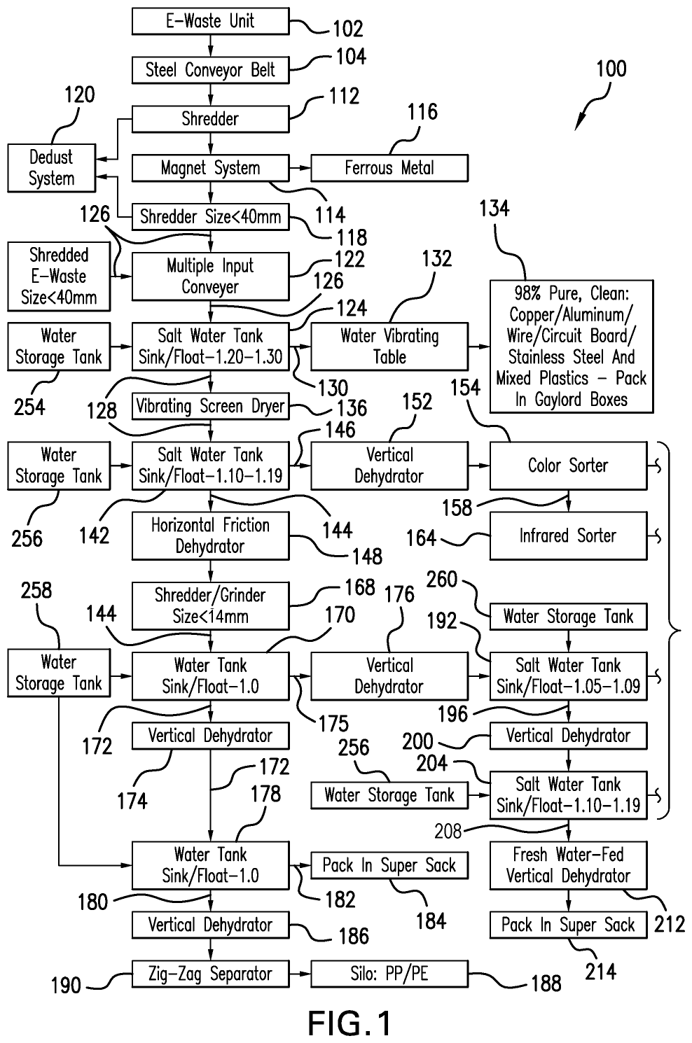

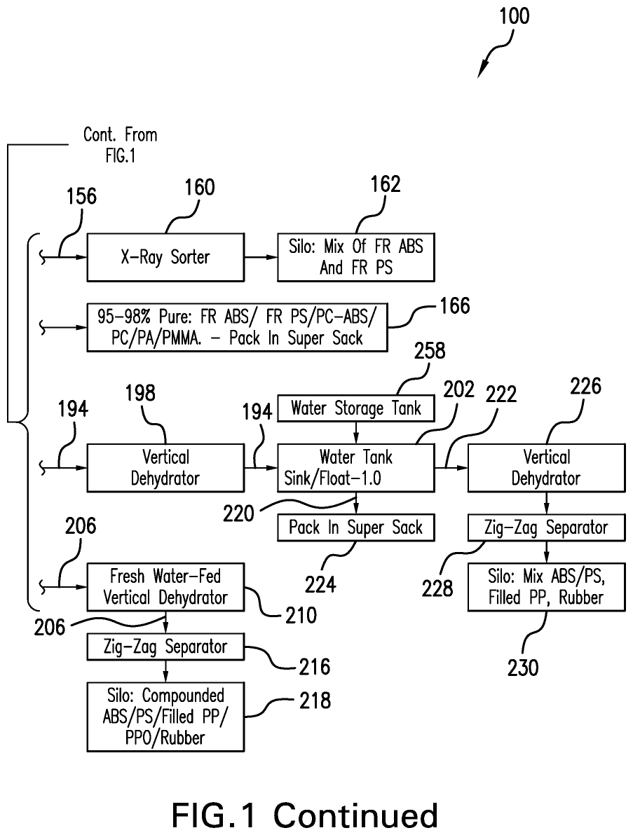

### DETAILED DESCRIPTION OF THE INVENTION

The invention herein includes various methods and embodiments thereof that improve performance of existing methods of recycling electronic waste by providing a higher level of purity and recovery of useful metals, precious metals and plastics for reuse in other electronic, manufacturing and/or consumer end applications.

As used herein, words such as “inner” and “outer,” “upper” and “lower,” “inwardly” and “outwardly,” “up” and “down,” “interior” and “exterior” and the like and words of similar import are used for understanding the invention with respect to the drawings herein and are not intended to be limiting absent language in the specification to the contrary.

The phrase “electronic waste” is meant to include waste resulting from various electronic products including but not limited to computer desktops, laptops, mobile phones, cameras, televisions, monitors, computer mice, keyboards, servers, printers and scanners, tablets, MP3 players, video recorders, DVD and DVR players, facsimile machines, video game players, cable boxes, a variety of consumer electronics including but not limited to vacuum cleaners and small kitchen appliances, electronic instrumentation and electronic manufacturing equipment of varying types, and is not intended to be limited to any particular type of electronic waste known or to be developed.

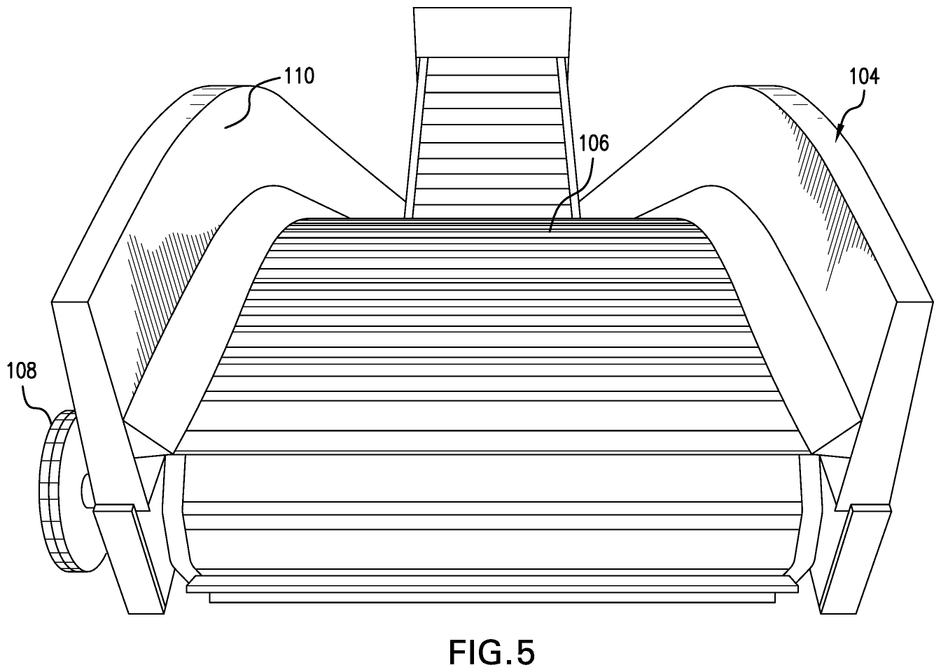

Such introductory electronic waste is feed material which is introduced into the process. It may be received directly, purchased or otherwise traded to provide feedstock to the methods herein. As shown in one preferred embodiment of the method, referred to herein generally as method 100, an item or items of electronic waste 102 is fed through a feed unit using a steel conveyor belt. However, it is preferred that batteries of any kind are first removed from the electronic waste 102 fed to the process. Any suitable feed unit or conveyor may be used. One suitable such steel conveyor is available commercially is from, e.g., Dongguan Ying Hao Machinery Co., Ltd., in Guangdong, China as Model Number M1450. A conveyor belt is preferably used that can withstand and properly deliver the electronic feed waste, such as a steel conveyor belt 104 as shown in FIG. 5, that has a large capacity to carry about 8 or more tons of electronic waste per hour (depending on the size of the recycling operation) including initial waste having iron materials (like printers, copiers, phones, modems, keyboards and the like and small appliances), and that demonstrates greater durability than standard rubber conveyor belts. The conveyor 104 preferably includes steel rotating tread 106 that is gear 108 driven, and has a steel frame such as guard rails 110 on either side of the conveyor for directing the electronic waste to a mechanism for reducing the size of the initial feed electronic waste 102.

The initial feed electronic waste 102 from the conveyor is directed to a first shredder. A suitable mechanism for shredding can include a variety of shredders, crushers, grinders and similar devices and one or more such devices may be used in tandem or in series. At least one shredder is used for initial reduction in size of the feed waste. An example of a suitable shredding mechanism in the form of a vertical shredder 112 is shown in FIG. 6 which may receive waste from conveyor 104. Such vertical shredders are available commercially, with one preferred model available from Zhengzhou Yong Can Mechanical Equipment Co., Ltd. as, e.g., Model Number 4000. Such materials are also available from other manufacturers such as Genox. The shredder is preferably able to process the capacity that may be delivered by the feed waste conveyor belt 104 and to reduce the size of such the waste feed materials 102 to an average width of about 60 mm or lower so that they may be separated as an initial matter into metal, printed circuit board and polymeric materials. In referring to an “average width” herein, it is meant to refer to the average size of incoming materials as measured in a longest dimension. It is preferred that at least about 95% of the incoming waste is reduced to or below the average width of 60 mm or lower. A variation in accuracy of such measurement of about ±10 mm is reasonably expected.

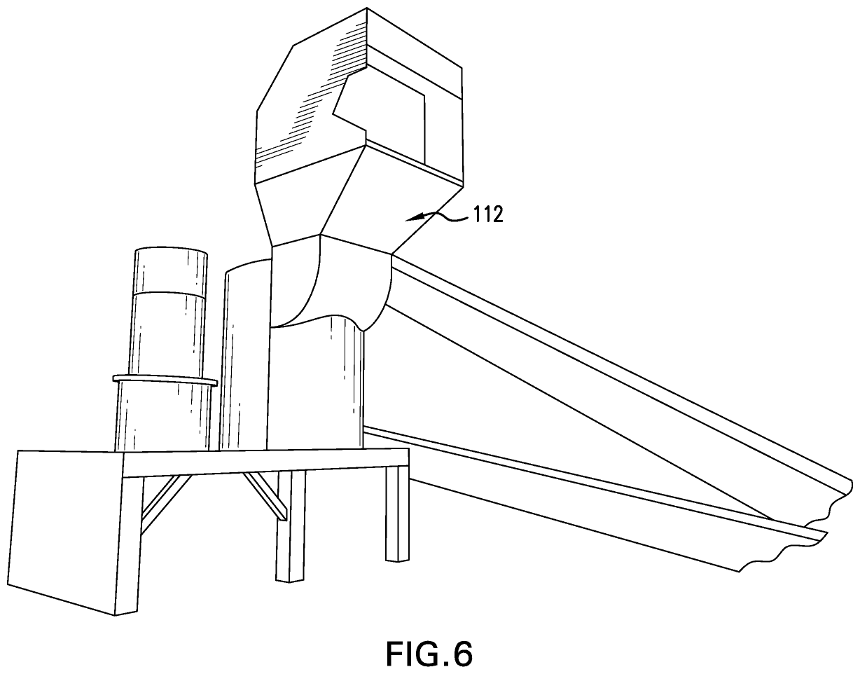

The shredder also operates in conjunction with a magnetic separator unit 114. Any suitable magnetic separator unit may be employed for this purpose. One such magnetic separator unit 114 is shown in FIG. 7. Suitable magnetic separators may also be obtained commercially from e.g., Linqu Shuang Te Mechanical Equipment Co., Ltd., China including Model Nos. LT 160/180. Such a unit 114 removes ferrous materials 116 from polymeric, filled polymeric and printed circuit board materials in the electronic waste. It is preferred that the magnetic separator is one that carries and handles at least about the same capacity of electronic waste as in introduced into the conveyor 104 and vertical shredder 112.

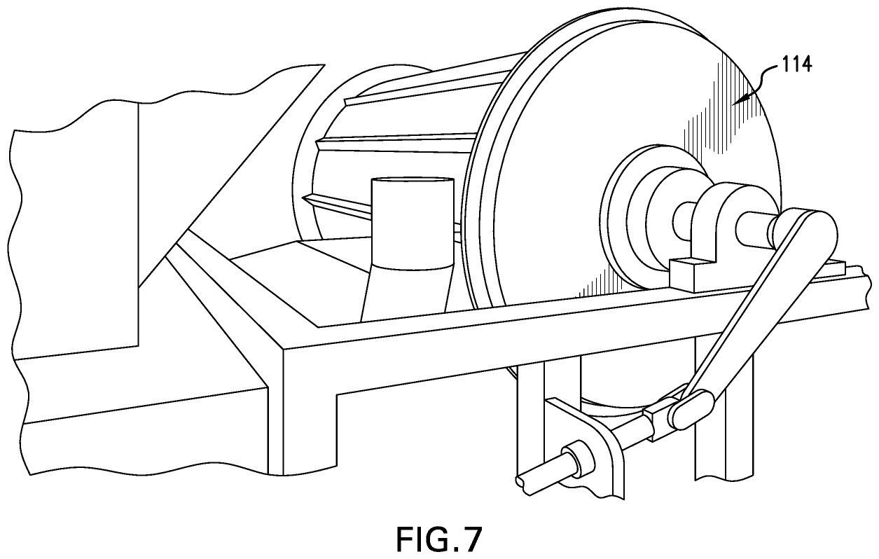

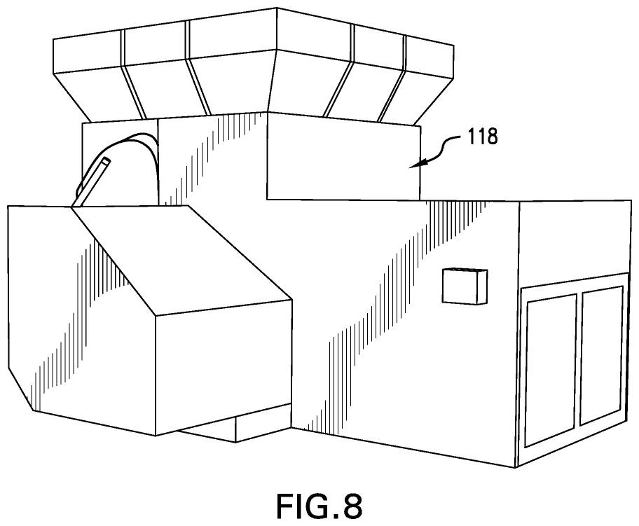

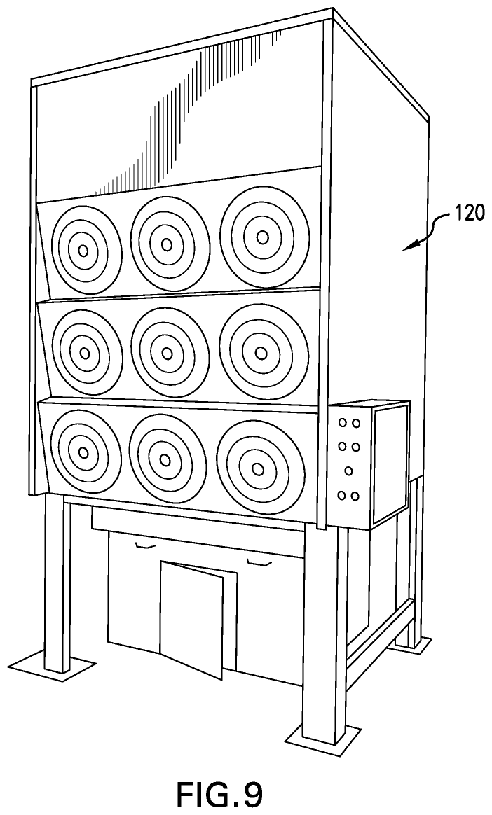

Separated waste leaving the magnetic separator unit 114 is preferably further reduced in size through a further shredder mechanism, such as, for example, a single shaft shredder 118 shown in FIG. 8 to be fed into the treatment phase of the process at an average width of about 40 mm or lower. Such a shredder 118 preferably also handles about the same or greater capacity of electronic waste as is fed to the vertical shredder 112 and magnetic separator unit 114. One suitable commercially available shredder may be found, e.g., as Model YSSJ from Zhang Jia Gang Yi Su Machinery Co., Ltd. of China. The electronic waste remaining with ferrous waste removed, including polymeric, filled polymer and printed circuit and other electronic board waste along with any other initial electronic waste feed which may be incorporated from other sources that is also about 40 mm or lower is fed to a first water tank. The alternative source of additional input electronic waste of about 40 mm or less may be purchased or may be recycled from output from either shredders 112 or 118 which are combined for introducing to the water tank. In all shredding and magnetic removal steps, it is preferred that a de-dusting system 120 is used to remove harmful dust or other loose particles in the air that may contribute to environmental or worker health issues. A suitable de-dusting apparatus 120 is shown in FIG. 9. Such units are commercially available and may be obtained through Kunshan Lucky Clover Environmental Technology Co., Ltd, of China as e.g., Model LC21-7.

A multi-unit conveyor belt or belts such as that shown, for example, as conveyor belt 122 of FIG. 10, introduces the combined feed of about 40 mm or less to the first water tank 124. Any suitable conveyor belt capable of delivering all or a reasonably portion of the feed capacity (as more than one conveyor belt may be used) are acceptable herein. Suitable conveyor belt(s) are commercially available from Dongguan Ying Hao Machinery Co., Ltd., e.g., Model Number S300. Such conveyors may be used to deliver the mixed shredded materials of size less than about 40 mm including any e-waste of such size reintroduced in combined form from the various shredders herein as feed waste (preferably after magnetic separation) to the first water tank as described further hereinbelow.

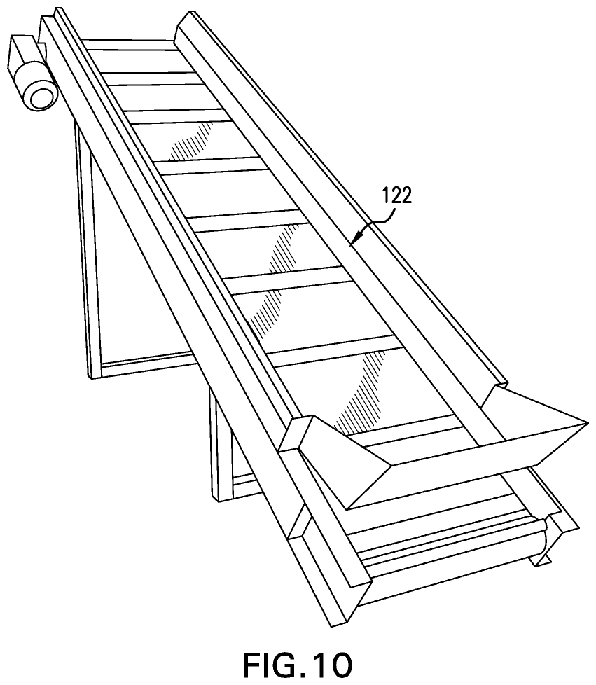

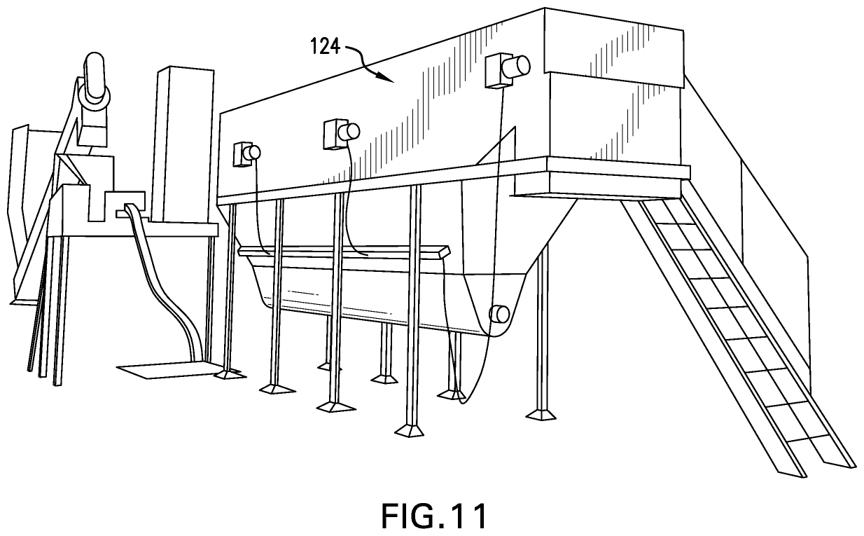

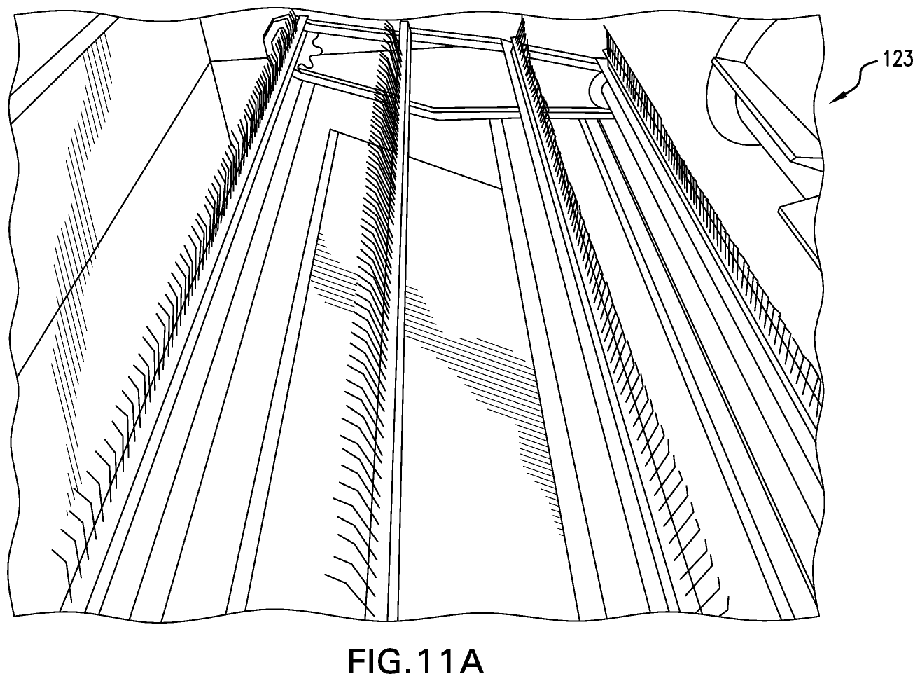

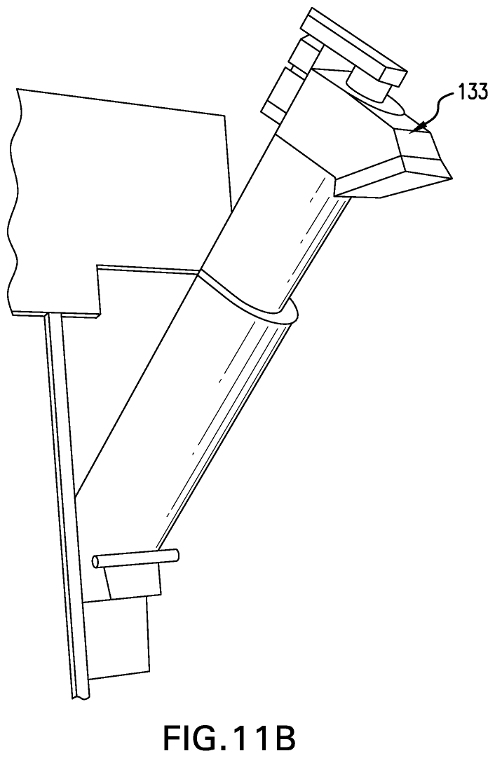

The separated electronic waste that has been subjected to magnetic separation and shredded to an average width of less than about 40 mm is introduced, such as by the conveyor belts 122 described above, to a first water tank 124. The first water tank, and other water tanks used herein for sink/float separation may be one such as the example tank shown in FIG. 11. Any suitable water sink/float tank known or to be developed for electronic waste separation may be used. Preferably such tanks include movement mechanisms at or near the bottom of the tank to move separated waste that sinks to the bottom of the tank through and out of the tank for removal and further treatment, such as augers, circular screw augers, and other pushing and rotating mechanisms. Floated material is drawn off the top of the tank using rotational or push mechanisms that scrape the upper portion of the tank, collect the material and transport it to a further tank. Examples of such mechanisms are shown as sink/float tank mechanism 123 in FIG. 11A.

The first tank 124 is one of a plurality of water sink/float tanks used in the method herein, wherein the plurality of water tanks each has a specific gravity that varies between about 1 and about 1.30. Some of the plurality of sink/float tanks used herein are fed with clean water of a specific gravity of about 1.0 as wash and sink/float tanks, and some are treated to have a varied specific gravity for successive separation of increasingly small or refined portions of the electronic feed waste 102 after treatment of initial shredding and magnetic separation to provide a feed electronic waste 126 that has the ferrous materials primarily removed by magnetic separation and the average width of the material shredded to about 40 mm or less.

The first water tank 124 preferably has a high end specific gravity of about 1.2 to about 1.30 and has a primary purpose of assisting in separation of metals from plastics. A first portion 128 of the electronic waste 126 is allowed to float in the first water tank 124 and is removed from the first water tank. The second portion 130 of the electronic waste 126 is allowed to sink in the first water tank 124. Preferably the tank used for separation as the first water tank 124 can handle the capacity of electronic waste delivered from the conveyor(s) 122 and allows for separation of the materials as described herein. Any suitable tank may be used. One preferred tank is commercially available from Dongguan Ying Hao Machinery Co., Ltd. as Model L8000 (which measures approximately 6500 mm×2000 mm×2300 mm and includes a four roller top for handling the electronic waste).

The second portion 130 of the electronic waste 126 that sinks in water tank 124 is sent to a water vibrating table 132. Such second portion of electronic waste from the bottom of the tank 124 is preferably introduced by a conveyor and/or piping or other conduit mechanism, such as mechanism 133. One suitable conveyance is shown, e.g., in FIG. 11B. However, any suitable conveyor with pumping or movement capacity or conduit system may be used for material transport with respect to the first water tank 124 or other separation sink/float tanks herein.

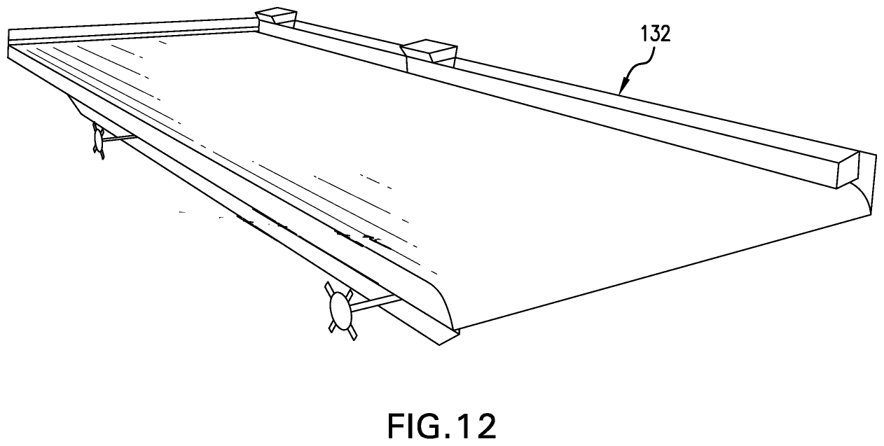

The sunken electronic waste (second portion of the electronic waste) is primarily comprised of plastics such as polyethylene terephthalate, polyvinyl chloride, polyoxymethylene and other plastics that may or may not be compounded or filled with glass, calcium carbonate or other traditional polymeric composite fillers used for electronic components. Also within the sunken waste in the second portion 130 of the electronic waste 126 in water tank 124, may be found nonferrous metals, circuit boards, gravel and silt. These materials are directed by conveyance to a water vibrating table, for example, the water vibrating table 132. A suitable vibrating table is shown in FIG. 12. Suitable commercial water vibrating tables are available, e.g., from Shi Cheng Wei Dai Mechanical Equipment Co., Ltd. of China including Model No. 8-S. The water vibrating table preferably operates so as to be able to handle at least the capacity of electronic waste introduced from the first water tank 124, and separates by gravity. It is preferably about 4 meters in length and preferably includes several separation discharge ports, preferably about 4 to about 6 such separation discharge ports, with six being most preferred. It is within the scope of the invention that such a vibrating table may be adjusted for height and/or angled for use.

From the operation of the water vibrating table, plastics and non-ferrous metals are completely separated from other impurities to at leave at least 98% pure and clean materials. The primary products 134 from this step are sorted recovered materials that include the 98% separated pure and clean copper, aluminum, wire, circuit boards, and stainless steel, which can be separated from the mixed plastics, and miscellaneous materials such as silt, stones and plastics.

In prior sink/float separation electronic waste recycling processes, a first treated water separation step was carried out using an eddy current sorting step. The sorting efficiency of the eddy current method yielded only about 80% sorting efficiency such that any separated plastic still retained about 15% to about 25% metal. To achieve this, it was also necessary to serially connect multiple such eddy current systems and/or use multiple sorting steps to distinguish metal from inside the plastic. Another disadvantage of this prior method was that stainless steel was not able to be sorted. The use of the vibrating table 132 in the method herein enables a sorting efficiency of about 98% or greater, and preferably about 99% increasing sorting efficiency and effectiveness substantially. It also enables separation and recovery of stainless steel.

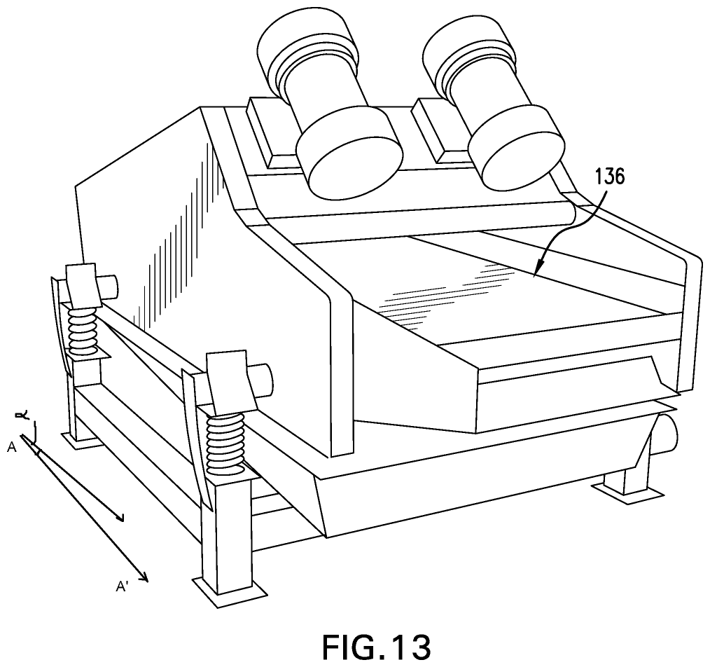

The first portion 128 of the electronic waste 126 from the first water tank 124 that floats in the water tank is preferably introduced to a vibrating screen dryer 136 as shown in FIG. 13. Any such vibrating screen dryer or dehydrator may be used. One suitable vibrating screen dryer is available commercially from ZhengZhou Jian Shi Machinery Co., Ltd. of China, e.g., Model Number 3YK1535 which provides a screen size of about 4 mm or less, a vibratory power of 970 R/min., and in operation removes about 93% of the water in the first portion of electronic waste from the first water tank. The first portion 128 that floats preferably includes materials like polypropylene, polyethylene, acrylonitrile-butadiene styrene, polystyrene, polyamide, polycarbonate/acrylonitrile-butadiene-styrene blends, polycarbonates and some composite polypropylene/calcium carbonate filler, flame retardant, polyphenylene oxides, and rubbers (elastomers). Such a vibrating screen dryer 136 which removes moisture and separates some powder and smaller pieces of materials. In prior float/sink separation processes in an initial separation stage, a horizontal spin dryer was used for such materials. Such dryers were effective but had negative aspects including high energy consumption and high speed requirements as they operate on centrifugal drying principles. It further, and significantly also causes damage to some materials with lower impact strength, including filler polypropylene, polystyrene and fiber reinforced materials that can be turned into powder. The dryers also used a large amount of steam with high salinity which leads to equipment and facilities corrosion.

By use of a vibratory screen dryer 136, such disadvantages are removed. Preferably, a vibrating screen is used having about 4 meters in length and an angle α with a longitudinal axis A-A′ running through a mounting floor 137 below the vibrating screen dryer 136 of about 5° to about 20°, and preferably about 10° to about 15°. It is also preferred to use a screen of about 0.71 mm mesh level, although these equipment parameters may be modified for different processes. In addition, elastomeric balls are preferably positioned underneath the screen such that the effectiveness provides a reduction in moisture down to less than about 5% of the production requirement and there is virtually no material damage from the treatment with no moisture created, avoiding corrosion issues and reducing energy consumption.

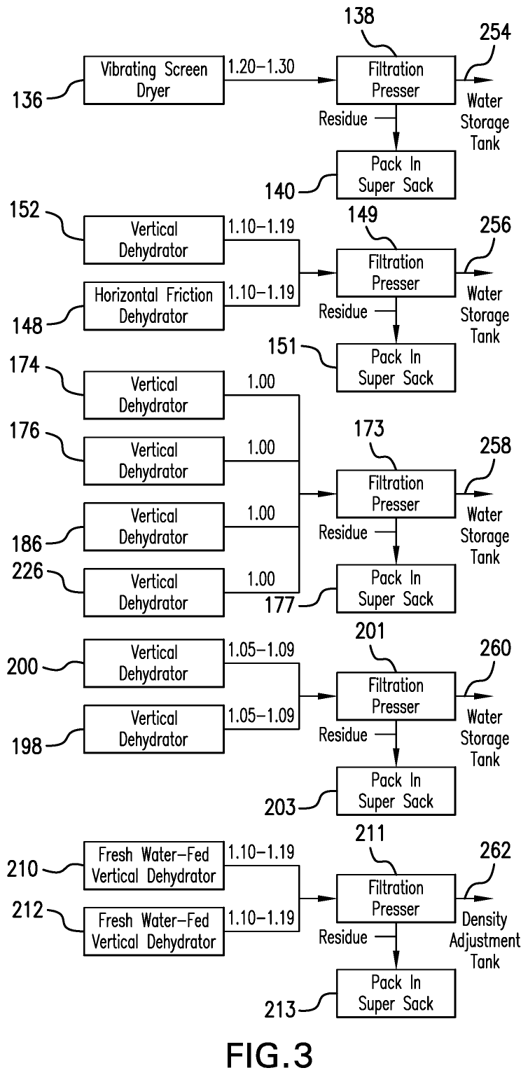

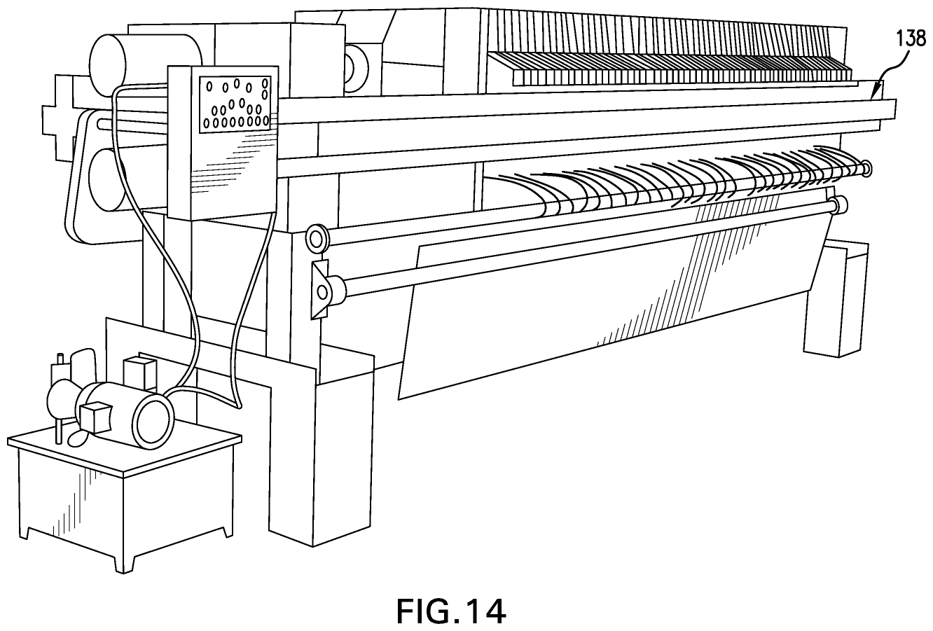

The materials and any water leaving as smaller particles enter a filtration press such as filtration press 138 shown in FIG. 14. Any suitable filtration presser may be used. A preferred commercial filtration press is commercially available from Hangzhou Chang You Environmental Technology Co., Ltd. e.g., Model Number XMZ100/100-UB. Such equipment has dimensions of about 6480 mm×1370 mm×1500 mm and a capacity of about 20 m³/hr. Slag water content is about 20%. The residue may be packed in a super sack 140 as in FIG. 3. The plastics remaining from the vibrating screen dryer are fed to a second water tank 142.

The remaining portion of floated materials in the dried first portion 128 of the electronic waste leaving the vibratory screen dryer 136 are then introduced to second water tank 142 which is treated to have a specific gravity of an intermediate level of about 1.10 to about 1.19. The second water tank 142 has as a primary function to remove the compounded plastics. The second water tank 142 allows a third portion 144 of the electronic waste to float in the second water tank 142 and a fourth portion 146 of the electronic waste to sink in the second water tank 142. The second water tank 142 may be made in the same manner and using the same equipment as the first sink/float treated water tank 124. The second water tank 142 separates into the fourth portion 146 of the electronic waste materials that sink in that tank including fiber-reinforced acrylonitrile-butadiene-styrene, fiber-reinforced polystyrene, polycarbonate/acrylonitrile-butadiene-styrene blends, polycarbonate and, to a lesser amount, polyamide, polypropylene filled with calcium carbonate, polyphenylene oxide and rubbers. The floating materials in the third portion 144 of the electronic waste materials are generally polypropylene, polyethylene, acrylonitrile-butadiene-styrene, rubber and some impurities, which may include, for example, labels, film and sawdust.

The third portion 144 of the floating electronic waste 126 is introduced into a horizontal friction dehydrator 148 as shown in FIG. 15. Such a device enables removal of moisture, surface dirt, labels removal and the like. Any suitable horizontal friction dehydrator may be used. One preferred, suitable commercial horizontal friction dehydrator is commercially available from DongGuan DingXiang General Machinery Co., Ltd. of China, e.g., Model Number DX-T3.5 which operates at a speed of about 800 rpm/min. and has a handling capacity of greater than about 6 tons/hr. It is preferred that the horizontal friction dehydrator 148 is able to handle at least the capacity of waste delivered in the third portion of the electronic waste from the second water tank 142. The horizontal frictional dehydrator is further preferably situated at an angle β of about 5° to about 40°, and preferably about 25° to 35°, more preferably about 30° from an axis B-B′ on a horizontal mounting surface 150 of the horizontal friction dehydrator 148 to reduce water content in the third portion 144 of the electronic waste 126 from the second water tank 142 and to assist in removal of at least dirt and labels from the third portion of the electronic waste to facilitate sorting. Such a horizontal friction dehydrator 148 in this position is an improvement over prior processes of sink/float separation processes that would employ a vertical dehydrator at this point. The change to a tilted horizontal friction dehydrator provides stability in the remaining water content of less than about 5% and the dirt and labels on the surface of the waste introduced are significantly reduced over prior processes, which creates favorable conditions for the fine sorting that will follows in the process.

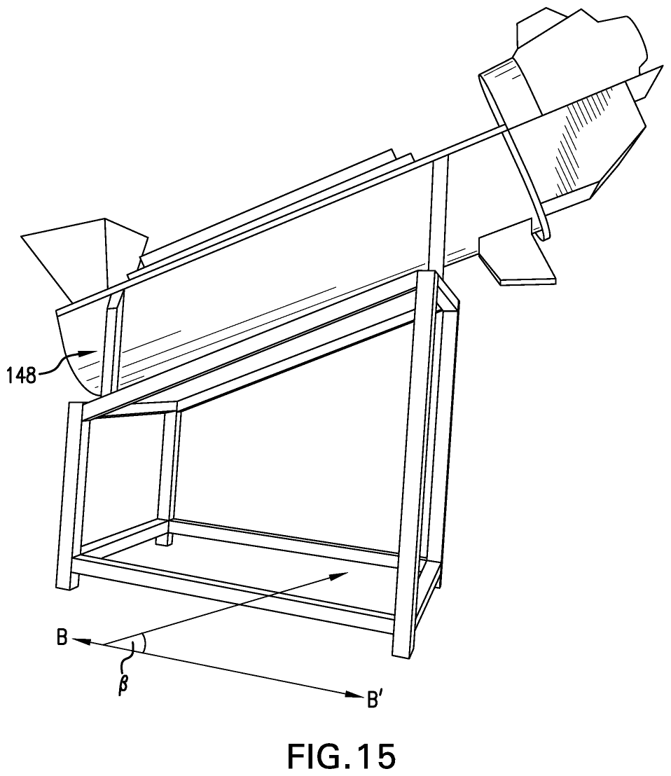

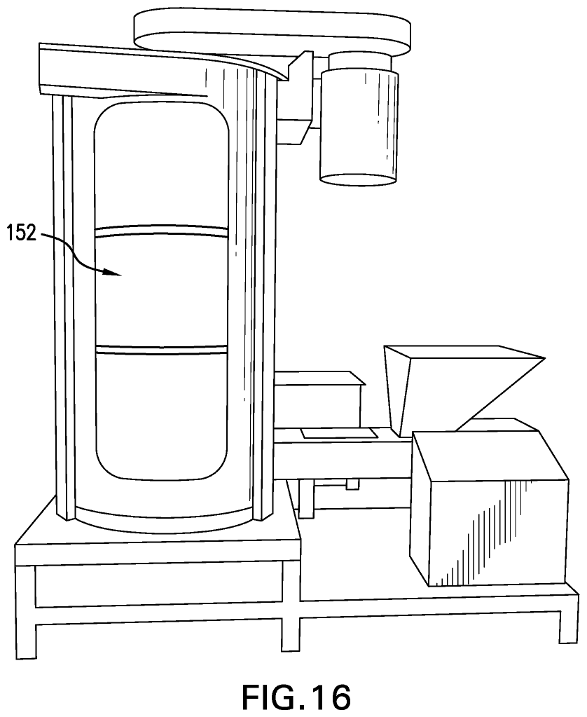

The fourth portion 146 of the electronic waste 126 that sinks in the second water tank 142 is introduced to a first vertical dehydrator 152. An example of such a vertical dehydrator which may be used as the first vertical dehydrator, or as any of the other vertical dehydrators mentioned hereinbelow in this method, is shown in FIG. 16. Suitable, preferred vertical dehydrators may be purchased commercially from, e.g., JiangSu HJ Centrifuge Manufacturing Co., Ltd. in China, e.g., as Model Number PL680. Such vertical dehydrators preferably have a capacity to process at least the electronic waste in the fourth portion 146 leaving the second water tank 142 as sunken material, and preferably at least about 5 tons/hour of plastics with water removal to about 95%. The first vertical dehydrator 152 dehydrates the sunken portion from the second water tank 142 and materials leaving the vertical dehydrator 152 enter a color sorter 154.

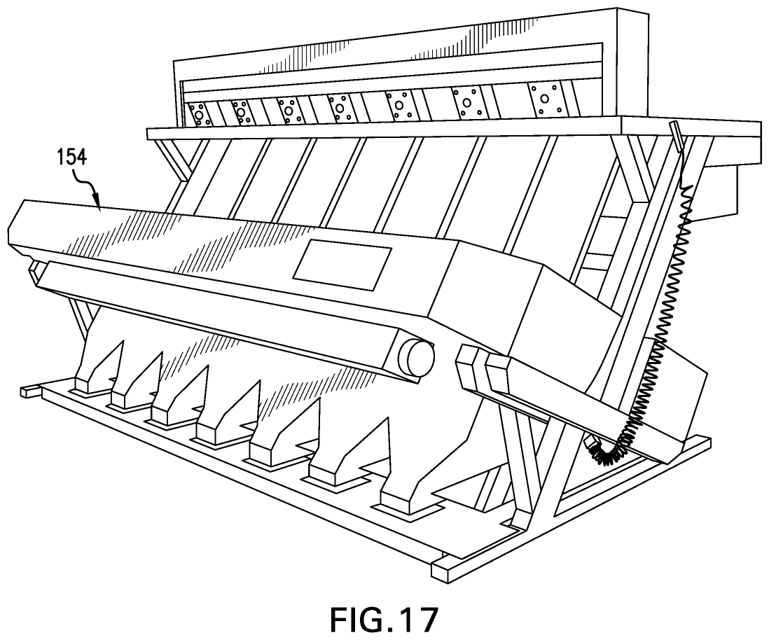

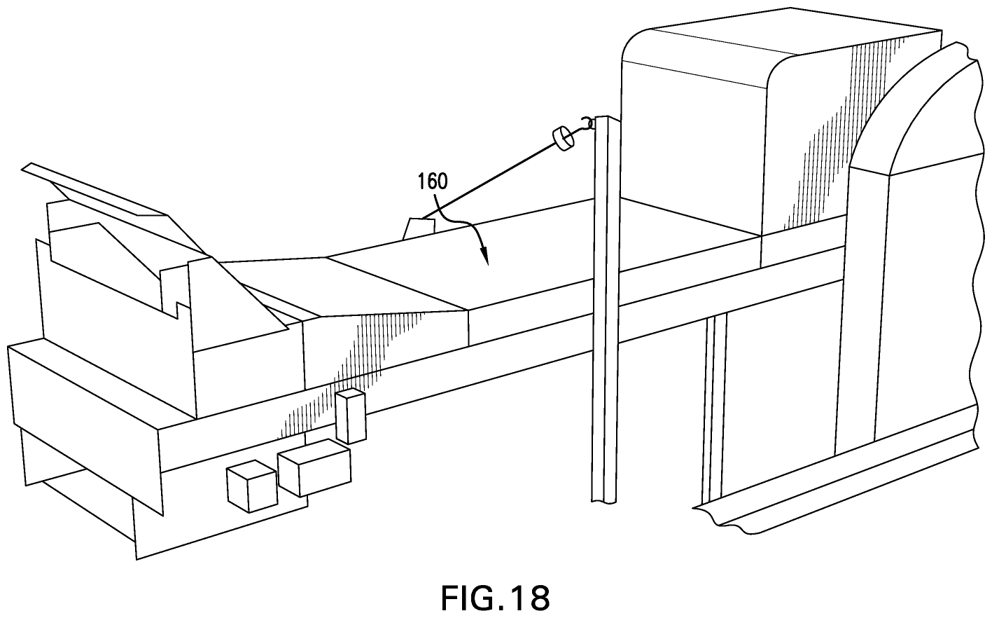

The color sorter 154 may be one such as shown in FIG. 17 and can be used to divide such materials into dark colored materials 156 and light colored materials 158. Suitable color sorters are available commercially, e.g., from AnHui BiTe Photoelectric Science and Technology, Ltd., including, e.g., Model Number BDM7-448. The color sorter should preferably have a capacity suitable for separating the fourth portion 146 of electronic waste leaving the first vertical dehydrator 152, e.g., at least about 3 tons/hr. The dark colored materials 156 are then introduced into an x-ray sorter 160 as shown in FIG. 18. Suitable X-ray sorters are commercially available from e.g., Tomra Sorting Solution, such as a Tomra X-tract sorter, e.g., Model XRT B-1200, and preferably have a capacity to handle at least about 3 tons per hour of waste. The X-ray sorter acts to separate materials containing flame retardants, and mainly black, fiber-reinforced acrylonitrile-butadiene-styrene and black, fiber-reinforced polystyrene which are placed in a first silo 162.

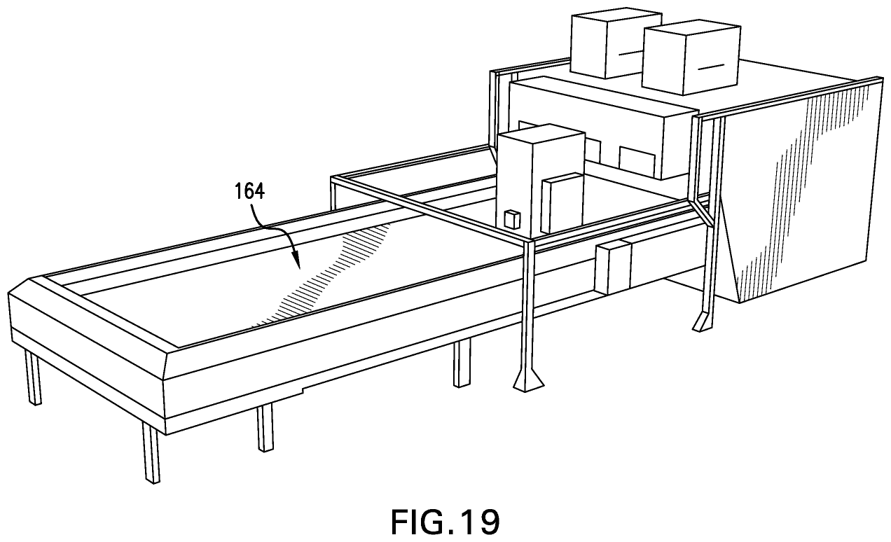

Light colored materials 158 from the color sorter 154 are introduced to an infrared sorter 164 which separates out pure, fiber-reinforced acrylonitrile-butadiene-styrene, fiber-reinforced polystyrene, polycarbonate/acrylonitrile-butadiene-styrene blends, polycarbonates, polyamides and polymethylmethacrylates and similar materials which are individually separated and may be further separately bagged in super sack 166. The light colored electronic waste in the infrared sorter 164 provide sorted plastics at about a 95% to about a 98% sorting efficiency. A suitable infrared sorter 164 is shown in FIG. 19. A preferred, commercially available infrared sorter may be found, for example, from Tomra Sorting Solution, e.g., Model Number NIR1 UHR-1800 having a handling capacity of about 3 tons/hour or more.

The third portion 144 of electronic waste 126 leaving the horizontal friction dehydrator 148 described above is preferably subjected to further size reduction. A shredder and crusher 168 is preferably used to reduce the materials to an average width of about 14 mm or less. A suitable shredder/crusher 168 is shown in FIG. 20. The size is preferably reduced to provide conditions that will be more suitable for electrostatic separation in the final stages of the method, and to reduce bubbling and other interference in the following third separation tank 170. Also removed are some small screws. A preferred, suitable shredder/crusher, may be obtained commercially, e.g., from ZhangJiaGang Bo Xin Machinery Co., Ltd. of China, as e.g., Model Number BXPSJ-2. Preferred shredder/crushers have sufficient capacity to handle the third portion 144 of electronic waste 125 leaving the horizontal friction dehydrator, for example, at least about 4 tons/hour and are fitted to crush the material to sizes under about 14 mm.

The third water tank 170 is a further float/sink separation tank that preferably is fed with water with a specific gravity of about 1. Such a tank may be the same as the first and second water tanks as noted above. The incoming third portion 144 of electronic waste 126 from the shredder/crusher 168 is separated in the third water tank 170 and washed. A fifth portion 172 of the electronic waste floats and is removed and send to a second vertical dehydrator 174. The materials that sink represent a sixth portion 175 of the electronic waste and is sent to a third vertical dehydrator 176. In the third water tank 170, the floating materials in the fifth portion 172 of the electronic waste preferably include polypropylene, polyethylene and trace amounts of acrylonitrile-butadiene-styrene, polystyrene, polypropylene filled with calcium carbonate, and rubber materials which enter the second vertical dehydrator 174. Such a second vertical dehydrator 174 may be the same type of equipment as the first vertical dehydrator 152. The sixth portion 175 of the electronic waste that sinks in the third water tank is preferably materials such as acrylonitrile-butadiene-styrene, polystyrene, polypropylene filled with calcium carbonate, and rubber materials. These materials enter the third vertical dehydrator 176.

The dried fifth portion 172 of the electronic waste 126 is introduced to a fourth water tank 178. The fourth water tank 178 is a tank like the third water tank 170 that includes water of a specific gravity of about 1.0 and may be of the same type and design depending on the capacity chosen for all water tanks in the process. This sink/float separation and wash tank separates the electronic waste into a seventh portion 180 of the electronic waste that floats and an eighth portion 182 that sinks. The floating materials in this stage are largely polyolefins, including polypropylene and polyethylene which are then removed for further processing. The materials that sink in the fourth water tank 178 are generally very small quantities of high-impact polystyrene, polypropylene filled with polycarbonate and rubber which may be removed and packed in a super sack 184.

The floating seventh portion 180 is preferably sent to a fourth vertical dehydrator 186 to remove moisture and dehydrate the polyolefins which are then further processed. The dried seventh portion 180 of the electronic waste leaving the fourth dehydrator 186 is separated and introduced to a second silo 188. The silos used herein, including the first and second silos as well as other silos described below preferably have a holding capacity to store about 20 m³ depending on the process capacity output. Suitable commercial silos that may be used are available, e.g., from Dongguan Ying Hao Machinery Co., Ltd. of China, as for example, Model Number 20.

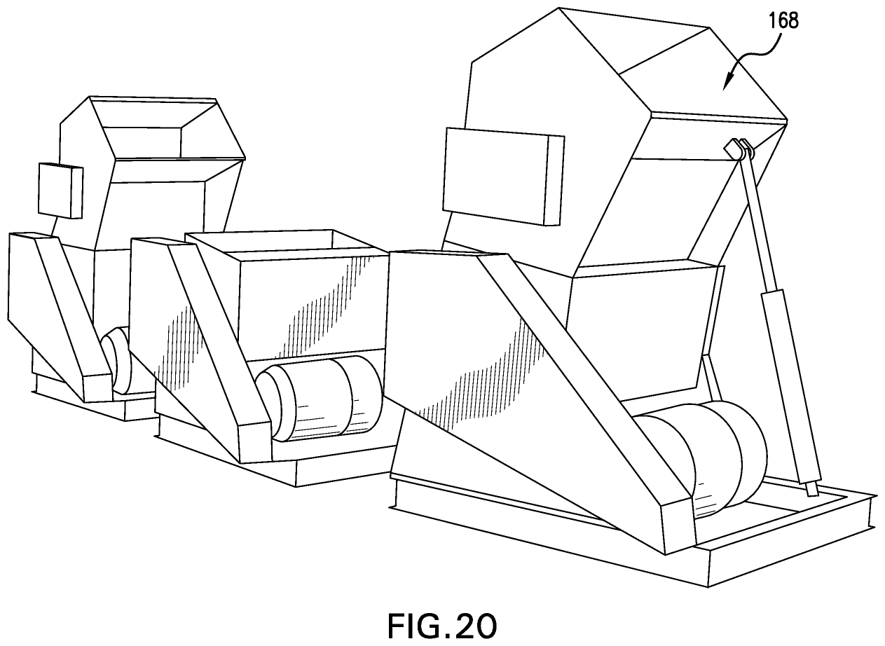

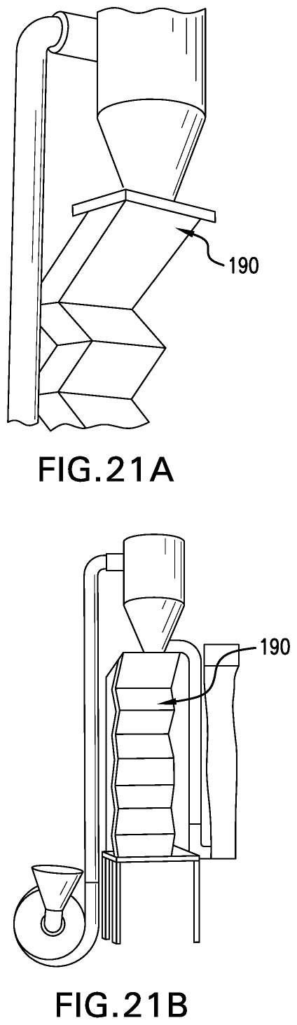

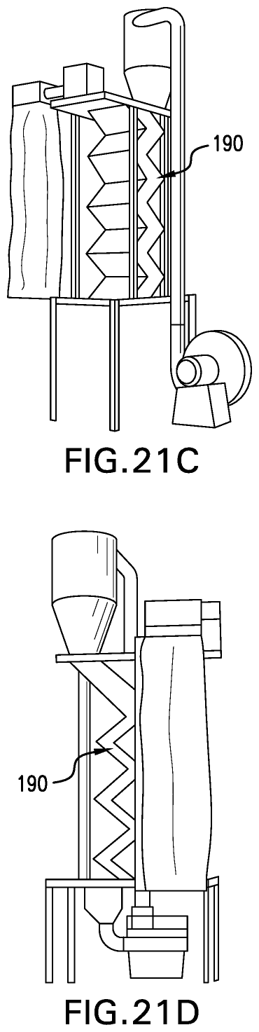

Separation post-dehydration may be conducted using a zig-zag separator 190. A suitable zig-zag separator 190 is shown in varying views in FIGS. 21A-21D. The zig-zag separator 190 enables removal of any films and labels. Materials from the zig-zag separator 190 are introduced into the second silo 188 for further optional processing. Zig-zag separators are preferably about to handle a suitable capacity of materials being fed for separation in accordance with the method designed, but preferably have a capacity of about 1 ton/hr removal of films, labels and the like and other light weight sundries. Suitable zig-zag separators are available commercial from, for example, DongGuan Grnwe Machinery Co., Ltd. of China, e.g. as Model Number GWFX-500H. Such separators have dimensions of about 2600 mm in length, 600 mm in width and 3500 mm in height.

The sixth portion 175 of the third water tank 170 after removal from the third water tank by sinking and dehydration in the third vertical dehydrator 176 is fed to a fifth water tank 192 which is mildly treated to have a specific gravity of about 1.05 to about 1.09 that primarily separates high grade from compounded materials. A ninth portion 194 of the electronic waste 126 in the fifth water tank 192 floats and a tenth portion 196 of the electronic waste 126 sinks in the fifth water tank 192. The ninth portion 194 and the tenth portion 196 of the electronic waste 126 are each fed respectively to a fifth vertical dehydrator 198 and a sixth vertical dehydrator 200. The ninth portion 194 of electronic waste leaving the fifth vertical dehydrator 198 is material that was removed by floating in the fifth water tank 192 and preferably includes high grade materials such as acrylonitrile-butadiene-styrene, high-impact polystyrene, polypropylene filled with calcium carbonate, and rubber. The sinking material in the tenth portion 196, preferably includes compounded materials such as acrylonitrile-butadiene-styrene, high-impact polystyrene, polypropylene filled with calcium carbonate and rubber which is fed to the sixth vertical dehydrator 200.

The ninth portion 194 of the floating materials of the fifth water tank 192 after dehydration in the fifth vertical dehydrator 198 is fed to a sixth water tank 202 of specific gravity of about 1.0. The tenth portion 196 of the sinking materials after dehydration in the sixth vertical dehydrator 200 enters a seventh water tank 204 of a specific gravity similar to that of the second water tank 142. Preferably, the seventh water tank 204 has a specific gravity of about 1.10 to 1.19. In the seventh water tank 204, the floating material is separated into an eleventh portion 206 of the electronic waste the floats and a twelfth portion 208 of the electronic waste that sinks. The eleventh floating portion 206 preferably includes lower grade acrylonitrile-butadiene styrene, high-impact polystyrene, polypropylene filled with calcium carbonate and rubber. The twelfth sinking portion 208 of the seventh water tank 204 preferably includes a small amount of fiber reinforced acrylonitrile-butadiene-styrene, fiber-reinforced polystyrene, polycarbonate and acrylonitrile-butadiene-styrene blends, polycarbonate, polyamide and rubber.

The eleventh floating portion 206 of the electronic waste 126 and the sinking twelfth portion 208 of the electronic waste leaving the seventh water tank 204 are each respectively fed into a first fresh-water fed vertical dehydrator 210 and a second fresh-water fed vertical dehydrator 212. The use of the fresh-water fed vertical dehydrators 210, 212 at this stage remove salinity while dehydrating the materials leaving the seventh water tank 204. The equipment for the vertical dehydrators may be the same as is used for the other vertical dehydrators herein, but fresh water is fed to the dehydrator(s) while in use. In prior processes where standard vertical dehydrators were used in a similar downstream phase, the surface of the material still may incorporate small amounts of salt or other specific gravity adjustment material which can cause instability in fine sorting of materials as well as corrosion of equipment. In the instant method, the fresh water feed port used to introduce fresh water feed to the vertical dehydrators 210, 212 improves the accuracy of the fine sorting and reduces corrosion of equipment.

The twelfth portion 208 leaving the second fresh-water fed vertical dehydrator may be packed in a super sack 214. The floating eleventh portion 206 after leaving the first fresh-water fed vertical dehydrator 210, is preferably further separated in a further zig-zag separator 216, which may be of the type as noted above with respect to zig-zag separator 190, to remove films and labels and is sent to be introduced into a third silo 218.

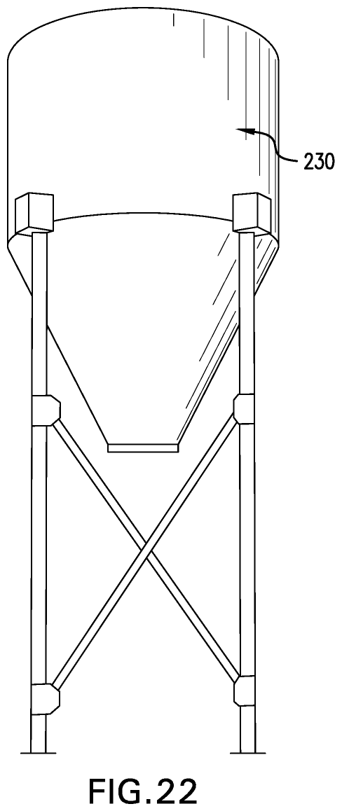

The floating ninth portion 194 leaving the fifth water tank 192 after dehydration by the fifth vertical dehydrator 198 that is fed to the sixth water tank 202 at a specific density of about 1 is then separated further into a thirteenth floating portion 220 and a fourteenth sinking portion 222. In the sixth water tank 202 the thirteenth portion 220 that floats may be packed in super sack 224 and includes preferably small amounts of polypropylene, polyethylene and some impurities. The fourteenth portion 222 of the electronic waste that sinks in the sixth water tank 202 is fed to a seventh vertical dehydrator 226 and the dried material is fed to a further zig-zag separator 228 (also which may be the same as that used for zig-zag separator 190) to remove films and labels and sent to a fourth silo 230. Such materials preferably include completely clean acrylonitrile-butadiene styrene, high-impact polystyrene, polypropylene filled with calcium carbonate, and rubbers. The silos may be any suitable silo and are preferably stainless steel. An example is shown in FIG. 22. This silo design may be used as well for silos 162, 188 and 218.

In the above preferred method, the plurality of water tanks, some of which are fed with water at a specific gravity of about 1.0 and some of which are treated so as to have a specific gravity of more than 1.0 and less than about 1.30, are used so as to allow electronic waste to separate by floating or sinking into separate portions of electronic waste. In certain cases, separated electronic waste from one or more of the plurality of water tanks is fed to a vertical dehydrator and a sorting apparatus, and the dehydrated and sorted electronic waste from such vertical dehydrators are introduced into silos, such as silos 162, 188, 218 and 230. After introducing the materials to silos as noted, the materials are preferably further processed by an electrostatic separation process 231.

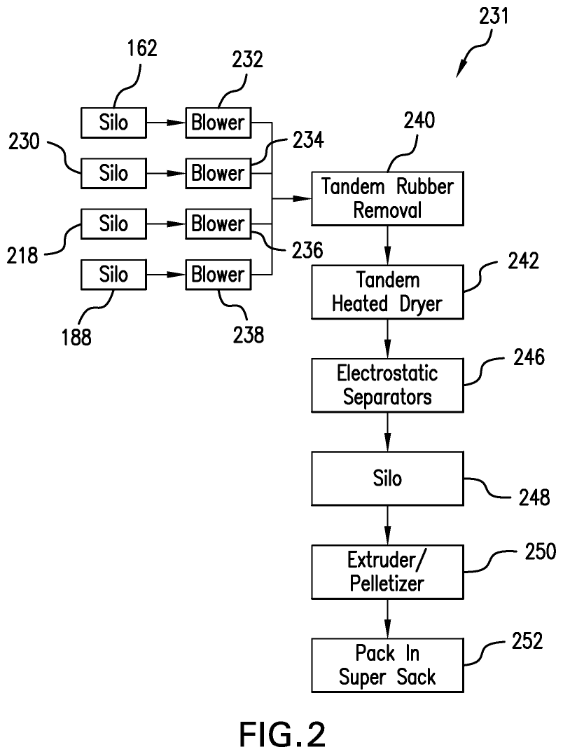

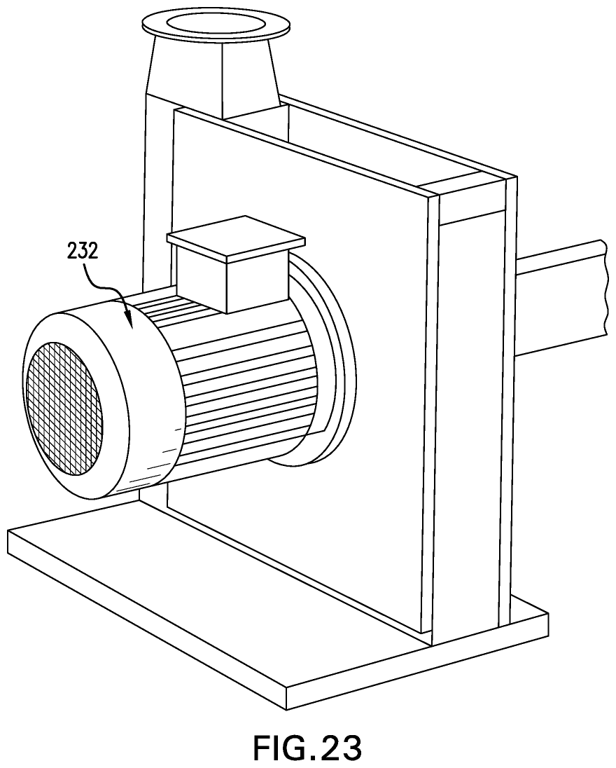

The recovered materials from the electronic waste in each of the silos when introduced into an electrostatic separation process 231 shown in FIG. 2, which is preferably used with the method herein. Each silo's material separately enters the process 231 preferably independently so as to encounter one of four blowers 232, 234, 236, and 238, each of which may be the same model as the example 232 shown in FIG. 23. Suitable blowers for use with the invention preferably have an air volume of about 3166 m³/min which should be suitable for the electronic waste processing capacity of the method described above, but such capacity may be varied depending on the initial separation process. Commercial blowers of this type are available, for example, from Shanghai Shah Yang Electromechanical Co., Ltd. of China, e.g., as Model Number 9-19.

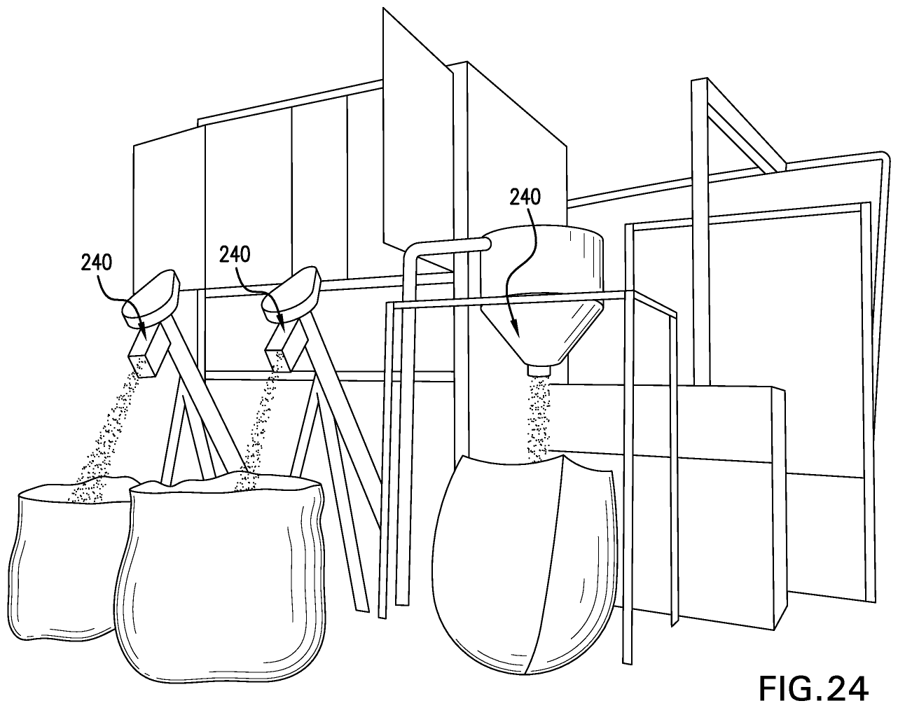

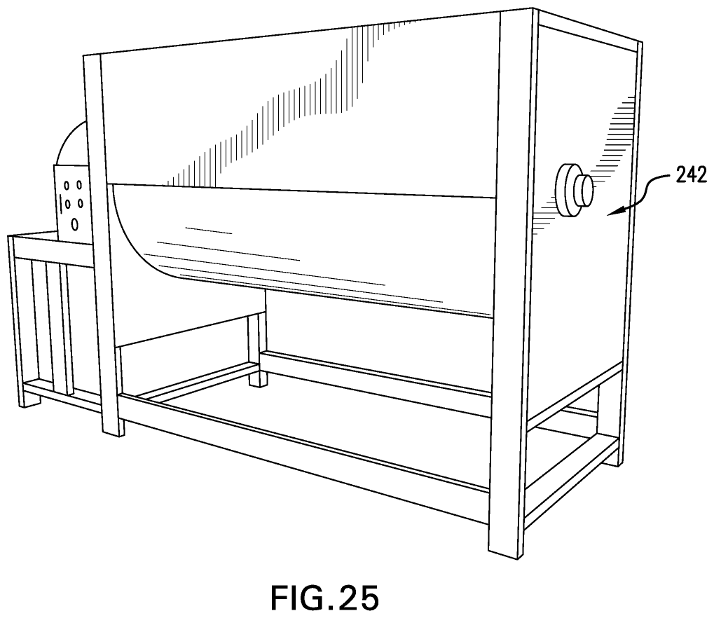

In a first step comprising applying the blowers, the particles are prioritized by type. The divided electronic waste enters a tandem rubber removal machine 240 that removes impurities such as rubber and silicon rubber as well as any sawdust or other dust into a tandem heated dryer 242, wherein an example of the tandem rubber removal machine is shown in FIG. 24, which reduces the moisture content by drying to be no greater than 0.02%. Suitable tandem rubber removal machines may be obtained, for example, from DongGuan HaiBao Machinery Co., Ltd. of China, e.g., as model 3000. Such materials are preferably able to handle a capacity of about 3 tons/hour and can remove impurities such as rubber, silicon rubber and sawdust in the materials. After the tandem dryer, shown in FIG. 25, the materials are introduced in a dry environment (with as little moisture present as possible) to an electrostatic separator 246 which separates the dry materials using friction and electrostatic separation. A suitable tandem dryer preferably has a capacity of about 3000 liters for such a process. Suitable tandem dryers are commercially available, for example, from DongGuan Fu Bang Machinery Co., Ltd. of China, e.g., as Model Number FB-W-1500 which has dimensions of about 3200 mm×1300 mm×2200 mm. Such dryers are effective in that they include a spiral structure in the outer spiral belt that coordinates with the rotation direction of the main shaft to drive the materials inside the cylinder wall to the central outlet so as to ensure that there are no dead angles in the material discharging from the cylinder body.

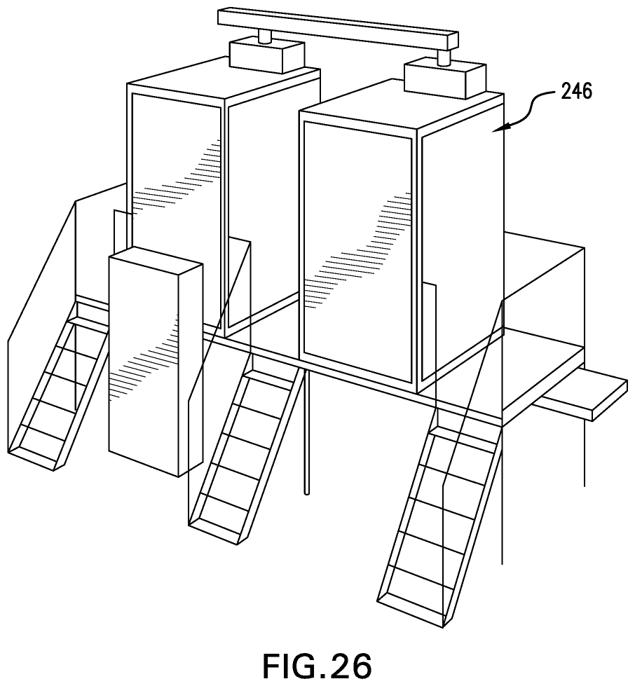

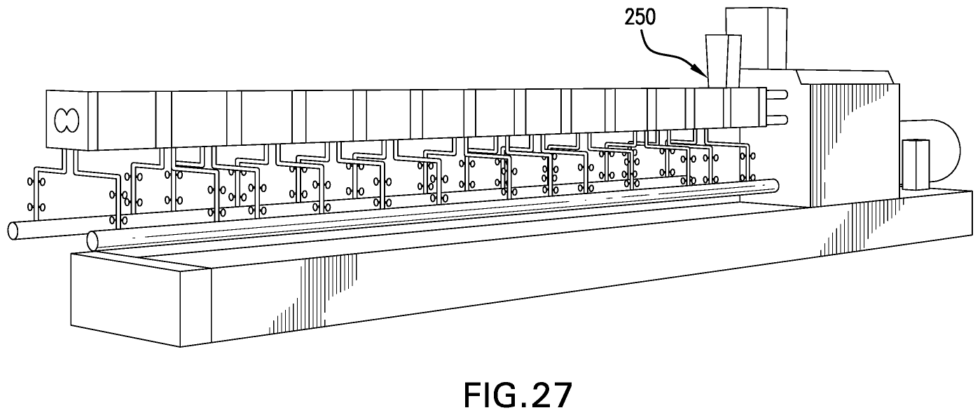

An example of an electrostatic separator 246 is shown in FIG. 26. Suitable commercial electrostatic separators are available commercially, for example, from Hamos Recycling GmbH, e.g., as Model No. EKS, for use as tandem electrostatic separator. Such electrostatic separators preferably have a capacity in a process as described above to handle at least about 3 tons/hr. This method allows for the purity of a single material to reach at least about 98% when run in an absolutely dry environment and using the electrostatic separator and process 231 as noted herein. A portion of such separated material is sent to a further silo 248 and stored for use in a pelletizer 250, an example of which is shown in FIG. 27 for pelletizing the material and packing such pelletized material in a super sack 252. Pelletizers and extruders are available commercially. One suitable pelletizer is available from Nanjing Hai Si Extrusion Equipment Co., Ltd. in China, e.g., Model No. SP95-200 which has a screw diameter of about 200 mm and a ratio of 7 to 12. Suitable such machines preferably have a capacity in this method of about 1 ton/hr.

After several rounds of cleaning, friction and fine separation, the material formed by the method reaches a high level of cleanliness and purity. After melting and pelletizing, finished product can be bagged and packed for sale, or the raw material prior to melting and pelletizing as packed and bagged throughout the process as discussed above may be sold as well.

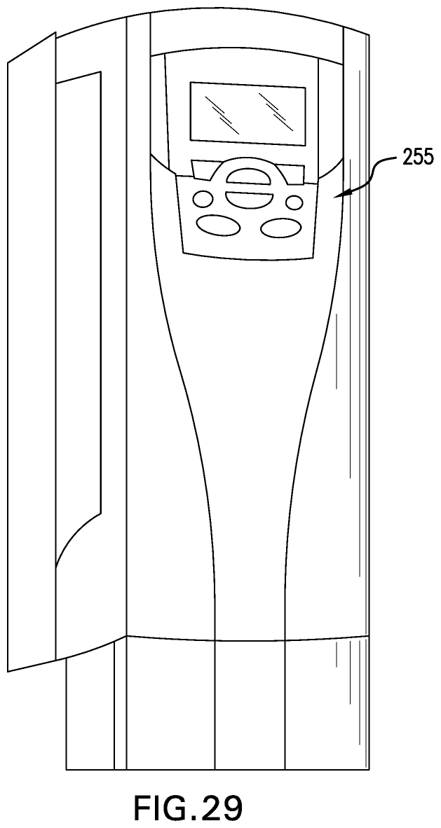

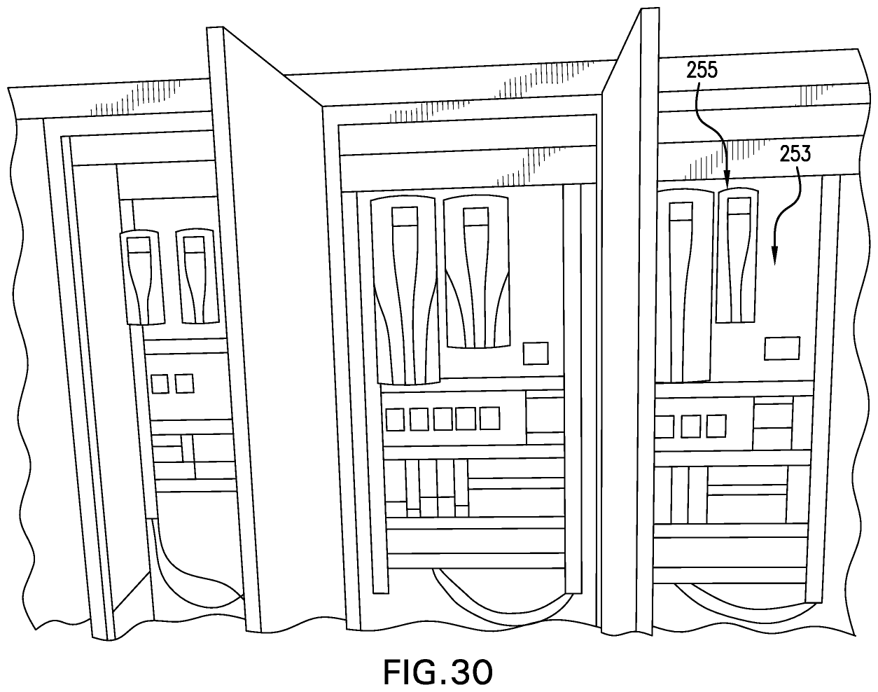

In another aspect of the method, each of the plurality of water tanks that comprises a rolling pusher or similar mechanism to move electronic waste through the water tank is made more efficient by providing a frequency converter control 255. Such frequency converter control is preferably situated on a control panel 253 associated with one or more water tanks, such as water tank 142. The frequency converter control 255 allows the process to control speed of operation and modify the speed of operation of the rolling pusher mechanism to adjust the efficiency of the process and tank residence time for float/sink separation. A suitable converter control 255 is shown in FIG. 29. A suitable such converter control is available commercially from ABB Group, e.g., as Model Number ACS 510. Preferably, the converter control operates at a voltage of about 380/480V. FIG. 30 provides an example of control panels 253 for the various water tanks including mounted frequency converter controls 255.

As shown in FIG. 3, moisture and impurities from various vertical dehydrators 152, 148, 174, 176, 185, 226, 200, 198, 210 and 212 from water tanks of varying specific gravity can be fed according to such specific gravity to separate filter presses, such as filter press 149 for moisture from dehydrators after water tanks having 1.10 to 1.19 specific gravity, filter press 173 for moisture from tank having specific gravity of 1.0, filter press 201 for moisture of specific gravity 1.05 to 1.09 and filter press 211 for moisture having specific gravity of 1.10 to 1.19 from the fresh-water fed vertical dehydrators. Each of the residues from the respective filter presses 149, 173, 201 and 211 may be packed in respective super sacks 151, 177, 203 and 213.

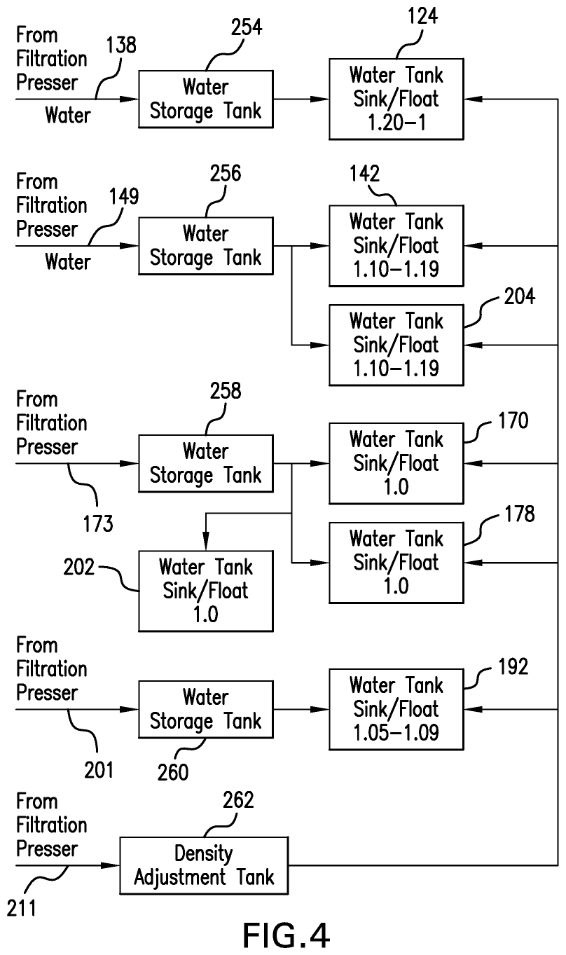

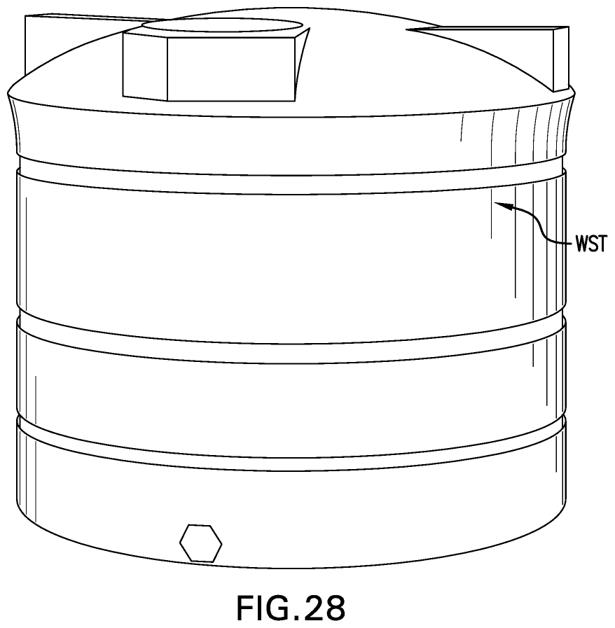

FIG. 4 illustrates the water feed to different water tanks used in the process. For example water enters from a main water feed to four separate water storage tanks 254, 256, 258 and 260 and one density adjustment tank 262. An example of a water storage tank is shown as WT in FIG. 28. Suitable water tanks may be commercially obtained from Plastic.Mart.com as Part Number CRMI-2000VT. Suitable tanks have storage capacity of about 2000 gallons for a process as described herein, but capacity may be varied with the process design. Such a tank would be approximately 90 in. in diameter and about 83 inches in height. Such tanks are used to store liquid of differing specific gravity as described herein for feeding such water to cleaning and separation tanks.

The first water storage tank 254 may be used to feed and supply the first water tank 124 for float/sink separation. The second water storage tank 256 is used to supply the second water tank 142 and the seventh water tank 204 each for float/sink separation. The third water tank is used to supply the water tanks having a specific gravity of 1.0, including float/sink water tanks 170, 178, and 202. Water storage tank four 260 is used to supply the fifth float/sink water tank 192. The water adjustment tank 262 is used to supply the correct amount of salt or other density adjustment material in water to the water tanks that are treated to have a specific gravity greater than about 1, including water sink/float tanks 124, 142, 192, and 204.

It will be appreciated by those skilled in the art that changes could be made to the embodiments described above without departing from the broad inventive concept thereof. It is understood, therefore, that this invention is not limited to the particular embodiments disclosed, but it is intended to cover modifications within the spirit and scope of the present invention as defined by the appended claims.

I claim:

1. A method for recycling electronic waste, comprising:
(a) providing separated electronic waste which has been subjected to magnetic separation to remove ferrous materials and shredded to an average width of less than about 40 mm;
(b) introducing the electronic waste from step (a) to a first water tank treated so as to have a specific gravity of about 1.20 to about 1.30 and allowing a first portion of the electronic waste to float in the first water tank and a second portion of the electronic waste to sink in the first water tank; and
(c) introducing the second portion of the electronic waste from step (b) to a water vibrating table, wherein the remaining second portion of the electronic waste from step (b) leaving the water vibrating table yields at least about 98% sorted recovered materials comprising pure and clean copper, aluminum, wire, circuit boards, stainless steel and mixed plastics.

2. The method according to claim 1, further comprising introducing the first portion of the electronic waste from step (b) to a vibrating screen dryer.

3. The method according to claim 2, further comprising introducing the dried first portion of the electronic waste from step (b) to a second water tank treated to have a specific gravity of about 1.10 to about 1.19 and allowing a third portion of the electronic waste to float in the second water tank and a fourth portion of the electronic waste to sink in the second water tank; and
(d) introducing the third portion of the electronic waste from step (c) to a horizontal friction dehydrator situated at an angle of about 5 degrees to about 40 degrees from a horizontal mounting plane of the horizontal friction dehydrator to reduce water content in the third portion of the electronic waste from the second water tank and to assist in removal of at least dirt and labels from the third portion of the electronic waste from step (c) to facilitate sorting.

4. The method according to claim 3, further comprising
(e) introducing the fourth portion of the electronic waste from step (c) to a first vertical dehydrator, and
(f) introducing the fourth portion of the electronic waste leaving the first vertical dehydrator into a color sorter to separate light colors from dark colors; and
(g) introducing the dark colored electronic waste into an X-ray sorter and introducing the light colored electronic waste into an infrared sorter to provide sorted plastics at about a 95% to about a 98% sorting efficiency of at least one of pure fiber reinforced acrylonitrile-butadiene-styrene, fiber reinforced polystyrene, polycarbonate, a polycarbonate-acrylonitrile-butadiene-styrene blend, acrylonitrile-butadiene-styrene, polyamide and polymethylmethacrylate.

5. The method according to claim 4, wherein the dark colored electronic waste is introduced into a first silo and comprises a mixture of fiber reinforced acrylonitrile-butadiene-styrene and fiber reinforced polystyrene.

6. The method according to claim 5, wherein the electronic waste in the first silo is introduced to an electrostatic separation process.

7. The method according to claim 3, further comprising introducing the third portion of electronic waste leaving the horizontal friction dehydrator to a shredder mechanism to reduce average width of the electronic waste to less than about 14 mm.

8. The method according to claim 7, wherein the third portion of electronic waste leaving the shredder mechanism is introduced to a third water tank and wherein a fifth portion of electronic waste from the shredder mechanism is allowed to float in the third water tank and a sixth portion of the electronic waste from the shredder mechanism is allowed to sink in the third water tank; wherein the fifth portion of the electronic waste and the sixth portion of the electronic waste are each introduced to a second and third vertical dehydrator, respectively, and the dried fifth portion of the electronic waste is introduced to a fourth water tank.

9. The method according to claim 8, wherein the fifth portion of the electronic waste in the fourth water tank is allowed to float or sink, a seventh portion of the electronic waste in the fourth water tank floats and is fed to a fourth vertical dehydrator and the dried seventh portion of the electronic waste leaving the second fourth dehydrator is separated and introduced to a second silo, wherein an eighth portion of the waste sinks in the fourth water tank and is packed, and wherein the seventh portion of the electronic waste in the second silo comprises polypropylene and polyethylene.

10. The method according to claim 9, wherein the seventh portion of electronic waste in the second silo is introduced to an electrostatic separation process.

11. The method according to claim 8, wherein the sixth portion of the electronic waste leaving the third vertical dehydrator is fed to a fifth water tank treated to have a specific gravity of about 1.05 to about 1.09 such that a ninth portion of the electronic waste in the fifth water tank floats and a tenth portion of the electronic waste sinks in the fifth water tank, the ninth and the tenth portions of the electronic waste are each fed to respective fifth and six vertical dehydrators, wherein the ninth portion of electronic waste leaving the fifth vertical dehydrator is fed to a sixth water tank and the tenth portion of electronic waste leaving the sixth vertical dehydrator is fed to a seventh water tank that has been treated to have a specific gravity of about 1.10 to about 1.19 such that the tenth portion of electronic waste is able to sink or float in the seventh water tank such that an eleventh portion of the electronic waste in the seventh water tank floats and a twelfth portion of the electronic waste in the seventh water tank sinks, wherein the eleventh and the twelfth portions of the electronic waste in the seventh water tank are each directed to respective first and second fresh water-fed vertical dehydrators.

12. The method according to claim 11, wherein the twelfth portion of electronic waste leaving the second fresh-water fed vertical dehydrator is packed and the eleventh portion of electronic waste leaving the first fresh-water fed vertical dehydrator is separated in a separation mechanism and introduced to a third silo.

13. The method according to claim 12, wherein the eleventh portion of the electronic waste from the third silo comprises compound acrylonitrile-butadiene-styrene, polystyrene, filler polypropylene, polyphenylene oxide and rubber.

14. The method according to claim 13, wherein the eleventh portion of the electronic waste in the third silo is introduced to an electrostatic separation process.

15. The method according to claim 11, wherein the ninth portion of the electronic waste in the sixth water tank is allowed to sink or float so that a thirteenth portion of the electronic waste floats and is packed and a fourteenth portion of the electronic waste sinks and is introduced to a seventh vertical dehydrator, separated and introduced to a fourth silo.

16. The method according to claim 15, wherein the fourteenth portion of the electronic waste in the fourth silo comprises a mixture of acrylonitrile-butadiene-styrene, polystyrene, filled polypropylene and rubber.

17. The method according to claim 16, wherein the fourteenth portion of the electronic waste in the fourth silo is fed to an electrostatic separation process.

18. A product made by the method of claim 1.

19. The product according to claim 18, wherein the remaining second portion of the electronic waste from step (b) leaving the water vibrating table yields at least about 99% sorted recovered materials comprising pure and clean copper, aluminum, wire, circuit boards, stainless steel and mixed plastics.

20. A method for recycling electronic waste, comprising:
(a) providing separated electronic waste which has been subjected to magnetic separation to remove ferrous materials and shredded to an average width of less than about 40 mm;
(b) introducing the electronic waste from step (a) to a first water tank treated so as to have a specific gravity of about 1.20 to about 1.30 and allowing a first portion of the electronic waste to float in the first water tank and a second portion of the electronic waste to sink in the first water tank; and
(c) introducing the first portion of the electronic waste from step (b) to a vibrating screen dryer, wherein the first portion of the electronic waste from step (b) comprises one or more of fiber reinforced polystyrene, unfilled polystyrene, fiber reinforced acrylonitrile-butadiene-styrene, unfilled acrylonitrile-butadiene-styrene, filled polyolefin, unfilled polyolefin, rubber, polycarbonate, polyamide, polymethylmethacrylate and polyphenylene oxide and wherein said vibrating screen dryer minimizes impact damage to the first portion of the electronic waste from step (b).

21. A product made by the method of claim 20.

22. A method for recycling electronic waste, comprising:
(a) providing separated electronic waste which has been subjected to magnetic separation to remove ferrous materials and shredded to an average width of less than about 40 mm;
(b) introducing the electronic waste from step (a) to a first water tank treated so as to have a specific gravity of about 1.20 to about 1.30 and allowing a first portion of the electronic waste to float in the first water tank and a second portion of the electronic waste to sink in the first water tank;
(c) drying the first portion of the electronic waste from step (b) and introducing the dried first portion of the electronic waste from step (b) to a second water tank treated to have a specific gravity of about 1.10 to about 1.19 and allowing a third portion of the electronic waste to float in the second water tank and a fourth portion of the electronic waste to sink in the second water tank; and
(d) introducing the third portion of the electronic waste from step (c) to a horizontal friction dehydrator situated at an angle of about 5 degrees to about 40 degrees from a horizontal mounting plane of the horizontal friction dehydrator to reduce water content in the third portion of the electronic waste from the second water tank and to assist in removal of at least dirt and labels from the third portion of the electronic waste from step (c) to facilitate sorting.

23. A product made by the method of claim 22.

24. A method for recycling electronic waste, comprising:
(a) providing separated electronic waste which has been subjected to magnetic separation to remove ferrous materials and shredded to an average width of less than about 40 mm;
(b) introducing the electronic waste from step (a) to a first water tank treated so as to have a specific gravity of about 1.20 to about 1.30 and allowing a first portion of the electronic waste to float in the first water tank and a second portion of the electronic waste to sink in the first water tank;
(c) drying the first portion of the electronic waste from step (b) and introducing the dried first portion of the electronic waste from step (b) to a second water tank treated to have a specific gravity of about 1.10 to about 1.19 and allowing a third portion of the electronic waste to float in the second water tank and a fourth portion of the electronic waste to sink in the second water tank;
(d) introducing the fourth portion of the electronic waste from the second water tank to a vertical dehydrator;
(e) introducing the fourth portion of the electronic waste leaving the vertical dehydrator into a color sorter to separate light colors from dark colors; and
(f) introducing the dark colored electronic waste into an X-ray sorter and introducing the light colored electronic waste into an infrared sorter to provide sorted plastics at about a 95% to about a 98% sorting efficiency of at least one of pure fiber reinforced acrylonitrile-butadiene-styrene, fiber reinforced polystyrene, polycarbonate, a polycarbonate-acrylonitrile-butadiene-styrene blend, acrylonitrile-butadiene-styrene, polyamide and polymethylmethacrylate.

25. A product made by the method of claim 24.

26. A method for recycling electronic waste, comprising:
(a) provided electronic waste prepared for recycling and subjecting such electronic waste to physical separation including by introducing the electronic waste to a plurality of water tanks, some of which are treated to have a specific gravity of more than 1.0 and less than about 1.3 and allowing a first portion of the electronic waste in the plurality of water tanks to float and a second portion of the electronic waste to sink;
(b) feeding separate electronic waste from one or more of the plurality of water tanks to a vertical dehydrator and a sorting apparatus;
(c) loading dehydrated and sorted electronic waste from each dehydrator in step (b) into a silo; and
(d) subjecting the electronic waste in each of the silos to electrostatic separation comprising applying blowers, feeding the electronic waste divided by the blowers further to a tandem rubber removal machine, using a tandem heated dryer to reduce moisture content, and separating the dry material using friction electrostatic separation.

27. The method according to claim 21, wherein the purity of the material after the electrostatic separation is at least about 98%

28. The method according to claim 21, wherein a portion of the material from the electrostatic separation is set aside for use in a pelletizing machine.

29. A product made by the method of claim 26.

30. The product of claim 29, wherein after electrostatic separation, the product has a purity of at least about 98%.

31. A method for recycling electronic waste, comprising
(a) providing electronic waste that has been reduced in average size for separation and sorting;
(b) introducing the electronic waste from step (a) to a plurality of water tanks, wherein some of the plurality of water tanks are treated to have a specific gravity of greater than 1.0 to about 1.30 and some of the plurality of water tanks have a specific gravity of about 1.0; and
(c) in each of the plurality of water tanks allowing a first portion of the electronic waste from step (b) to float in each of the plurality of water tanks and a second portion of the electronic waste to sink in each of the at least one water tanks, wherein one water tank of the plurality of water tanks comprises a rolling pusher mechanism to move electronic waste through the water tank, and wherein the water tank having the rolling pusher mechanism comprises a frequency converter control situated on the water tank for allowing for modification of the speed of operation of the rolling pusher mechanism.

32. A method for recycling electronic waste, comprising
(a) providing electronic waste that has been reduced in average size for separation and sorting;
(b) introducing the electronic waste from step (a) successively to a plurality of water tanks, wherein some of the plurality of water tanks are treated to have a specific gravity of greater than 1.0 to about 1.30 and some of the plurality of water tanks have a specific gravity of about 1.0 allowing for a first portion of the electronic waste in each of the plurality of water tanks to float and a second portion of the electronic waste in each of the plurality of water tanks to sink; and
(c) introducing each of the first portion and the second portion of the electronic waste from the last of the plurality of water tanks that are treated into an independent fresh water-fed vertical dehydrator.
